(19) United States
(12) Patent Application Publication
(10) Pub. No.: US 2026/0118800 A1
(43) Pub. Date: Apr. 30, 2026

(54) IMAGE FORMING APPARATUS

(71) Applicant: CANON KABUSHIKI KAISHA, Tokyo (JP)

(72) Inventor: KOICHI TANIGUCHI, Tokyo (JP)

(21) Appl. No.: 19/367,357

(22) Filed: Oct. 23, 2025

(30) Foreign Application Priority Data
Oct. 25, 2024 (JP) 2024-188679

(51) Int. Cl. G03G 15/16; G03G 15/00

(52) U.S. Cl. CPC G03G 15/161; G03G 15/80

(57) ABSTRACT

An image forming apparatus includes a photosensitive member, an intermediary transfer belt, a transfer member, an electrode member provided on a side downstream of the transfer portion with respect to a movement direction of the intermediary transfer belt and on an inner peripheral surface side of the intermediary transfer belt, a power source for applying a voltage of the same polarity as a predetermined polarity to the electrode member, an electrode member supporting portion, and an elastically deformable and electrically insulative elastic sheet member provided to the supporting portion so as to contact the inner peripheral surface of the intermediary transfer belt and provided in a region extending across a rectilinear line drawn so as to connect the transfer member and the electrode member in a shortest distance when the elastic sheet member is viewed substantially parallel to a widthwise direction of the intermediary transfer belt.

### FIELD OF THE TECHNOLOGY

The present disclosure relates to an image forming apparatus such as a copying machine, a printer, a facsimile machine, or a multi-function machine having a plurality of functions of these machines, using an electrophotographic type or an electrostatic recording type.

### DESCRIPTION OF THE RELATED ART

As an image forming apparatus, such as a color copying machine, a color printer, or a color multi-function machine, using the electrophotographic type, an image forming apparatus of an intermediary transfer type becomes mainstream since the image forming apparatus has advantages such that downsizing of an apparatus main assembly and adaptation to various recording materials are relatively easy. The image forming apparatus of the intermediary transfer type includes, in general, a constitution provided with a plurality of photosensitive drums and an intermediary transfer belt. Further, in such an image forming apparatus, toner images formed on the photosensitive drums are electrostatically primary-transferred successively onto the intermediary transfer belt in primary transfer portions. Then, the toner images primary-transferred on the intermediary transfer belt are electrostatically secondary-transferred onto a recording material such as paper in a secondary transfer portion. Incidentally, with respect to an arrangement of members around the primary transfer portions, “upstream” and “downstream” refer to “upstream” and “downstream”, respectively, with respect to a conveying direction of the intermediary transfer belt unless otherwise particularly specified.

In the image forming apparatus as described above, toner on the intermediary transfer belt has a tendency such that on a side downstream of a primary transfer portion, the toner is subjected to electric discharge between the intermediary transfer belt and the photosensitive drum and thus a charge amount of the toner increases. Then, the charge amount of the toner on the intermediary transfer belt increases, so that it becomes hard to transfer the toner onto a recording material in the secondary transfer portion in some instances. For example, a secondary transfer electric field necessary to transfer the toner onto the recording material in the secondary transfer portion becomes large, so that graininess of the image becomes worse and uniform transfer of the toner onto embossed paper with surface unevenness or the like becomes difficult in some instances.

Here, in Japanese Laid-Open Patent Application No. 2003-57963, a constitution in which an electroconductive contact plate is provided on a side downstream of the primary transfer portion and on an inner peripheral surface side of the intermediary transfer belt and in which a bias of the same polarity as a charge polarity of a photosensitive drum is applied to the contact plate is disclosed.

In order to suppress the increase in charge amount of the toner on the side downstream of the primary transfer portion as described above, suppression of the electric discharge on the side downstream of the primary transfer portion is effective. Further, in order to suppress this electric discharge, it is effective that a potential difference between the photosensitive drum and the intermediary transfer belt after the toner passes through the primary transfer portion is made small. Further, for that purpose, it is effective that an electroconductive electrode member is provided on the side downstream of the primary transfer portion and on the inner peripheral surface side of the intermediary transfer belt and the bias of the same polarity as the charge polarity of the photosensitive drum is applied to this electrode member.

However, the polarity of the bias applied to the electrode member is the same as the charge polarity of the photosensitive drum and is opposite to a polarity of a bias applied to the primary transfer member forming the primary transfer portion. For that reason, in the case where the electrode member is disposed close to the primary transfer portion and the bias applied to the electrode member is made high or in the like case, a large potential difference is generated between the electrode member and the primary transfer member. Further, by this potential difference, there is a possibility that electric discharge (leakage) through a space between the primary transfer member and the electrode member occurs. By this, for example, there is a possibility that an effect of suppressing the electric discharge between the intermediary transfer belt and the photosensitive drum by the electrode member is reduced.

### SUMMARY

The present disclosure is directed to suppress electric discharge through a space between a primary transfer member and an electrode member in a constitution in which a bias of the same polarity as a charge polarity of a photosensitive member is applied to the electrode member provided downstream of a primary transfer portion.

This is achieved by an image forming apparatus according to the present disclosure.

According to an aspect of the present disclosure, there is provided an image forming apparatus comprising: a photosensitive member capable of being electrically charged to a predetermined polarity and configured to bear a toner image; an intermediary transfer belt configured to convey the toner image transferred from the photosensitive member and capable of being circulated and moved; a transfer member forming a transfer portion, where the photosensitive member and the intermediary transfer belt contact each other, in contact with an inner peripheral surface of the intermediary transfer belt, and configured to transfer the toner image from the photosensitive member onto the intermediary transfer belt in the transfer portion under application of a voltage; an electrode member provided on a side downstream of the transfer portion with respect to a movement direction of the intermediary transfer belt and on an inner peripheral surface side of the intermediary transfer belt; and a power source configured to apply a voltage of the same polarity as a predetermined polarity to the electrode member; a supporting portion configured to support the electrode member; and an elastic sheet member provided to the supporting portion so as to contact the inner peripheral surface of the intermediary transfer belt and which is elastically deformable and electrically insulative, the elastic sheet member being provided in a region extending across a rectilinear line drawn so as to connect the transfer member and the electrode member in a shortest distance when the elastic sheet member is viewed substantially parallel to a widthwise direction of the intermediary transfer belt.

Further features of the present disclosure will become apparent from the following description of embodiments with reference to the attached drawings. The following description of embodiments are described by way of example.

### BRIEF DESCRIPTION OF THE DRAWINGS

FIG. 1 is a schematic sectional view of an image forming apparatus.

FIG. 2 is a schematic block diagram of a control system of the image forming apparatus.

Parts (a) and (b) of FIG. 3 are a schematic sectional view and a schematic perspective view, respectively, of a potential regulating member.

FIG. 4 is a schematic sectional view of the potential regulating member in another example.

FIG. 5 is a schematic sectional view of the potential regulating member in another example.

FIG. 6 is a schematic sectional view for illustrating an arrangement of the potential regulating member.

FIG. 7 is a schematic sectional view for illustrating a constitution and an arrangement of a shielding member.

FIG. 8 is a plan view for illustrating a constitution and an arrangement of the shielding member with respect to a longitudinal direction.

FIG. 9 is a schematic sectional view for illustrating a force relationship between the shielding member and the potential regulating member.

FIG. 10 is a schematic sectional view for illustrating a constitution and an arrangement of a shielding member in a modified embodiment.

FIG. 11 is a schematic sectional view for illustrating a force relationship between a shielding member and a potential regulating member in another embodiment.

### DESCRIPTION OF THE EMBODIMENTS

In the following, an image forming apparatus according to the present disclosure will be described in more detail with reference to the drawings.

### Embodiment 1

### 1. General Structure and Operation of Image Forming Apparatus

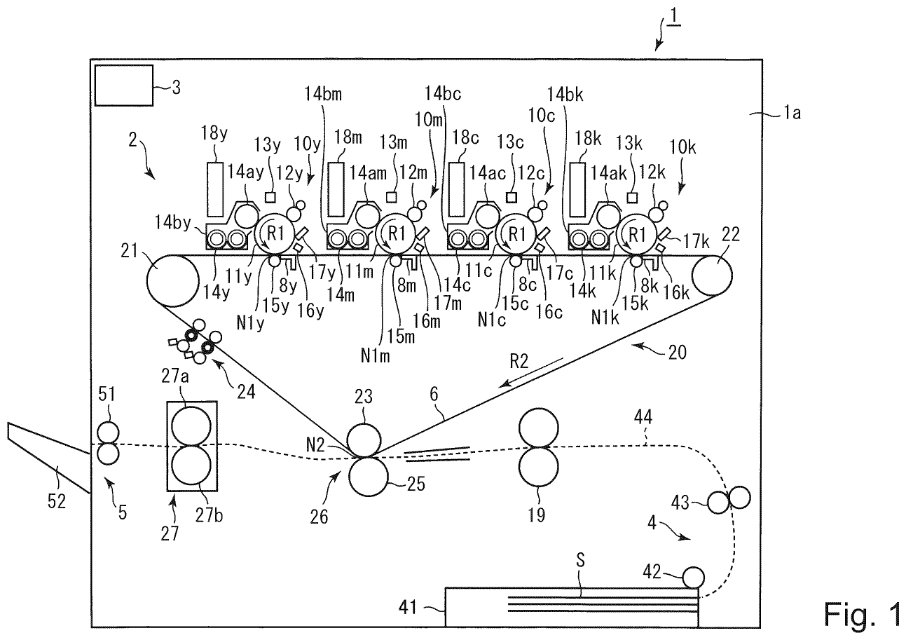

First, a general structure and an operation of the image forming apparatus of this embodiment will be described. FIG. 1 is a schematic sectional view of an image forming apparatus 1 of this embodiment. The image forming apparatus 1 of this embodiment is a tandem type full-color printer capable of forming a full-color image on a sheet-like recording material S by using an electrophotographic type and employing an intermediary transfer type.

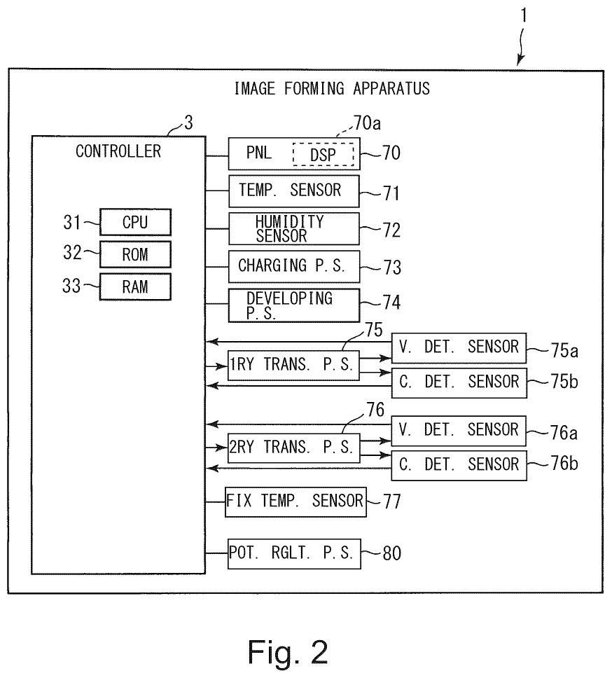

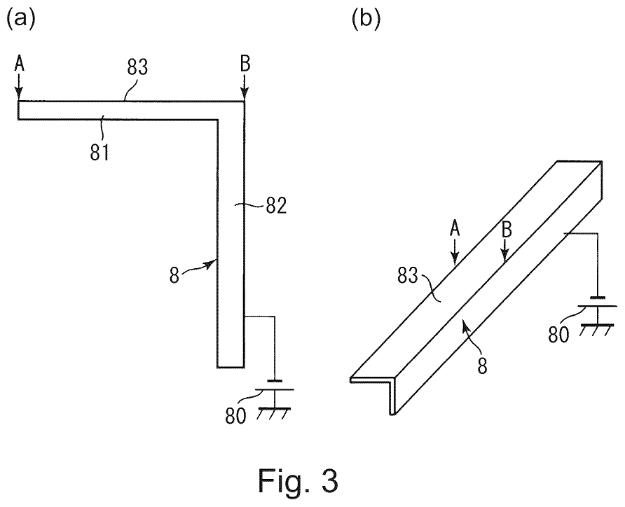

The image forming apparatus 1 includes image forming portion 2, a controller 3, a feeding portion 4 of the recording material S, and a discharging portion 5 of the recording material S. Further, inside the image forming apparatus 1, a temperature sensor 71 (FIG. 2) capable of detecting a temperature inside the apparatus and a humidity sensor 72 (FIG. 2) capable of detecting a humidity inside the apparatus are provided. The image forming apparatus 1 is capable of forming an image on the recording material S on the basis of image information (image signal) acquired by an original reading apparatus (not shown) provided on the image forming apparatus 1 or connected to the image forming apparatus 1. Further, the image forming apparatus 1 is capable of forming an image on the recording material S on the basis of image information (image signal) from an external device (not shown), such as a personal computer (host device), a digital camera, or a smartphone, connected to the image forming apparatus 1. Incidentally, the recording material (transfer material, recording medium, sheet) S is a material on which a toner image is formed. Specific examples of the recording material S include plain paper, thick paper, gloss coated paper, mat coated paper, embossed paper, or synthetic resin sheets (synthetic paper) which are substitutes for plain paper or the like, and an overhead projector sheet (resin film). Here, the recording material S is referred to as “paper” (“paper”, “embossed paper”, “high-resistance paper”, or the like) in some instances, but even in that case, the recording material S includes a material other than the paper or a recording material formed with a material containing the material other than the paper.

The image forming portion 2 forms the image on the recording material S, fed from the feeding portion 4, on the basis of the image information. The image forming portion 2 includes image forming units 10y, 10m, 10c, 10k, toner bottles 18y, 18m, 18c, 18k, exposure devices 13y, 13m, 13c, 13k, an intermediary transfer unit 20, a secondary transfer device 26, and a fixing device 27. The image forming units 10y, 10m, 10c and 10k form toner images of colors of yellow (y), magenta (m), cyan (c), and black (k), respectively. Incidentally, elements having the same or corresponding functions or structures provided for the respective colors will be collectively described by omitting suffixes y, m, c and k for representing elements for associated colors, respectively, in some instances. Further, the image forming apparatus 1 can also form, for example, a single-color image such as a (single) black image or a multi-color image by using the image forming unit(s) 10 for a desired single color or some of the four colors.

The image forming unit 10 includes a photosensitive drum 11 which is a drum-type (cylindrical) photosensitive member (electrophotographic photosensitive member) as an image bearing member. In addition, the image forming unit 10 includes a charging roller 12 which is a roller-type charging member as a charging means. In addition, the image forming unit 10 includes a developing device 14 as a developing means. In addition, the image forming unit 10 includes a pre-exposure device 16 as a discharging (charge eliminating) means. In addition, the image forming unit 10 includes a drum cleaning device 17 as a photosensitive member cleaning means. The image forming unit 10 forms a toner image on an intermediary transfer belt 6 described hereinafter.

The photosensitive drum 11 is movable (rotatable) while carrying (bearing) an electrostatic image (electrostatic latent image) or a toner image. In this embodiment, the photosensitive drum 11 is a drum-type photosensitive member provided with a negatively chargeable organic photosensitive member (OPC), and an outer diameter thereof is 30 mm. This photosensitive drum 11 is electrically chargeable to a negative polarity as a predetermined polarity. The photosensitive drum 11 includes an aluminum cylinder as a substrate and a surface layer (photosensitive layer) formed on the surface of the substrate. In this embodiment, as the surface layer, three layers of an undercoat layer, a charge generation layer, and a charge transportation layer, which are applied and laminated on the substrate in the order named are provided. When an image forming operation is started, the photosensitive drum 11 is rotationally driven in a direction indicated by an arrow R1 (counterclockwise) direction in FIG. 1 at a predetermined peripheral speed (process speed) by a driving motor (not shown) as a driving means.

The surface of the rotating photosensitive drum 11 is uniformly electrically charged by the charging roller 12. In this embodiment, the charging roller 12 is a rubber roller which contacts the surface of the photosensitive drum 11 and which is rotated with the rotation of the photosensitive drum 11. To the charging roller 12, a charging power source 73 (FIG. 2) as a charging voltage applying means (charging voltage applying portion) is connected. The charging power source 73 applies a predetermined charging voltage (charging bias) to the charging roller 12 during the charging process.

The surface of the charged photosensitive drum 11 is scanned and exposed by the exposure device 13 on the basis of the image information, so that an electrostatic image is formed on the photosensitive drum 11. The exposure device 13 is a laser scanner in this embodiment. The exposure device 13 emits laser beam (light) in accordance with separated color image information outputted from the controller 3, and scans and exposes the surface (outer peripheral surface) of the photosensitive drum 11.

The electrostatic image formed on the photosensitive drum 11 is developed (visualized) by supplying the toner thereto by the developing device 14, so that a toner image (toner picture, developer image) is formed on the photosensitive drum 11. In this embodiment, the developing device 14 is a two-component developing device using, as a developer, a two-component developer comprising toner (non-magnetic toner particles) and a carrier (magnetic carrier particles). In a developing container (developing container main body) 14b of the developing device 14, the two-component developer is accommodated, and toner in an amount corresponding to a consumed amount of the toner is supplied from the toner bottle 18. The developing device 14 includes a developing sleeve 14a as a developing member (developer carrying member). The developing sleeve 14a is constituted by, for example, a non-magnetic material such as aluminum or non-magnetic stainless steel (aluminum in this embodiment). Inside the developing sleeve 14a, a magnet roller (not shown) which is a roller-shaped magnet as a magnetic field-generating means (magnetic field-generating member) is fixed and arranged so as not to rotate relative to the developing container 14b. The developing sleeve 14a carries the two-component developer and conveys it to a developing region opposing the photosensitive drum 11. Then, in the developing region, the toner is moved to and deposited on an image portion of the electrostatic image on the photosensitive drum 1 from the two-component developer on the developing sleeve 14a. A developing power source 74 (FIG. 2) as a developing voltage applying means (developing voltage applying portion) is connected to the developing sleeve 14e. The developing power source 74 applies a predetermined developing voltage (developing bias) to the developing sleeve 14a during the development. In this embodiment, on an exposed portion (image portion) on the photosensitive drum 11 lowered in absolute value of the potential by being exposed after being uniformly charged, the toner charged to the same polarity (negative polarity in this embodiment) as the charge polarity of the photosensitive drum 11 is deposited (reverse development type). In this embodiment, a normal charge polarity of the toner, which is a principal charge polarity of the toner during the development, is the negative polarity.

The intermediary transfer unit 20 is arranged so as to oppose the four photosensitive drums 11y, 11m, 11c and 11k. The intermediary transfer unit 20 includes the intermediary transfer belt 6 which is constituted by an endless belt as an intermediary transfer member. The intermediary transfer belt 6 is wound around and stretched by, as a plurality of stretching rollers, a driving roller 21, a tension roller 22, and an inner secondary transfer roller 23. The intermediary transfer belt 6 is movable (rotatable, capable of being circulated and moved) while carrying the toner image. The driving roller 21 is rotationally driven by a driving motor (not shown) as a driving means, so that a driving force is transmitted to the intermediary transfer belt 6, and thus the intermediary transfer belt 6 is rotated (circulated and moved) in an arrow R2 direction (clockwise direction) in FIG. 1 at a predetermined peripheral speed corresponding to the peripheral speed of the photosensitive drum 1. The tension roller 22 controls the tension of the intermediary transfer belt 6 to be constant. The tension roller 22 is subjected to a force which pushes the intermediary transfer belt 6 from an inner peripheral surface (back surface) side toward an outer peripheral surface (front surface) side by an urging force of a tension spring (not shown) constituted by a compression coil spring which is an urging member as an urging means. By this force, a tension of about 2 to 5 kgf is applied to the intermediary transfer belt 6 in the feeding (conveying) direction (process progression direction, movement direction) of the intermediary transfer belt 6. The inner secondary transfer roller 23 constitutes a secondary transfer device 26 in combination with an outer secondary transfer roller 25 described hereinafter. On the inner peripheral surface side of the intermediary transfer belt 6, primary transfer rollers 15y, 15m, 15c, and 15k, which are roller-type primary transfer members as primary transfer means, are provided correspondingly to the photosensitive drums 11y, 11m, 11c, and 11k, respectively. In this embodiment, the primary transfer rollers 15 are disposed opposed to the photosensitive drums 11 and nip the intermediary transfer belt 6 between themselves and the photosensitive drums 11. Each of the primary transfer rollers 15 is pressed toward the photosensitive drum 11 and contacts the photosensitive drum 11 by way of the intermediary transfer belt 6, and forms a primary transfer portion (primary transfer nip) N1 which is a contact portion between the photosensitive drum 11 and the intermediary transfer belt 6.

The toner image formed on the photosensitive drum 11 is transferred (primarily transferred) onto the intermediary transfer belt 6 in the primary transfer portion N1 by the action of the primary transfer roller 15. For example, during formation a full-color image, the yellow, magenta, cyan and black toner images formed on the photosensitive drums 11 are multiple-transferred so as to be sequentially superimposed on the intermediary transfer belt 6. A primary transfer power source 75 (FIG. 2) as a primary transfer voltage applying means (primary transfer voltage applying portion) is connected to the primary transfer roller 15. During the primary transfer, the primary transfer power source 75 applies, to the primary transfer roller 15, a primary transfer voltage (primary transfer bias) which is a DC voltage having an opposite polarity (positive polarity in this embodiment) to the normal charge polarity of the toner. By this, the toner image formed with toner having the negative polarity on the photosensitive drum 11 is primarily transferred onto the intermediary transfer belt 6. To the primary transfer power source 75, a voltage detecting sensor 75a (FIG. 2) as a voltage detecting means (voltage detecting portion) which detects an output voltage thereof and a current detecting sensor 75b (FIG. 2) as a current detecting means (current detecting portion) which detects an output current thereof are connected. In this embodiment, for example, a primary transfer voltage of about 1 to 2 kV is applied to the primary transfer roller 15 (as regards a numerical range, “1 to 2 kV” shows a range including 1 kV and 2 kV, and the same applies hereinafter). In addition, in this embodiment, the primary transfer voltage is subjected to constant-voltage control. In this embodiment, the primary transfer power sources 75y, 75m, 75c and 75k are provided independently of the primary transfer rollers 15y, 15m, 15c and 15k, respectively. Further, in this embodiment, the primary transfer voltages applied to the primary transfer rollers 15y, 15m, 15c and 15k can be individually controlled.

Here, in this embodiment, the primary transfer roller 15 has a core metal and an elastic layer of ion conductive foam rubber (NBR rubber) formed at a periphery of the core metal. An outer diameter of the primary transfer roller 15 is, for example, 15 to 20 mm. In addition, as the primary transfer roller 15, a roller having an electric resistance value of 1×10⁵ to 1×10⁸Ω (measured at N/N (23° C., 50% RH), 2 kV applied) can be preferably used.

Further, in this embodiment, the intermediary transfer belt 6 is an endless belt having a two-layer structure including a base layer, and a surface layer in the order named from the inner peripheral surface side toward the outer peripheral surface side. As the material constituting the base layer, a resin such as polyimide or polycarbonate, in which an appropriate amount of carbon black is contained as an antistatic agent can be suitably used. A thickness of the base layer is, for example, 0.05 to 0.15 mm. As a material constituting the surface layer, a resin such as chloroprene rubber (CR) to which electroconductivity is imparted by carbon black can be suitably used. A thickness of the surface layer is, for example, 0.200 to 0.300 mm. In this embodiment, the intermediary transfer belt 6 has a volume resistivity of 5×10⁸ to 1×10¹⁴ Ω·cm (23° C., 50% RH). Incidentally, in this embodiment, the two-layer structure was employed in the intermediary transfer belt 6, but a single-layer structure of a material corresponding to the material of the above-described base layer may also be employed. Further, the surface layer may also be formed as a resin-coated layer, of about 0.002 to 0.01 mm in thickness, containing a resin material such as a fluorine-containing resin. Further, the intermediary transfer belt 6 may have a multi-layer structure of three or more layers.

On the outer peripheral surface side of the intermediary transfer belt 6, the outer secondary transfer roller 25 which is a roller-type secondary transfer member as a secondary transfer means is provided. The outer secondary transfer roller 25 as the secondary transfer member constitutes the secondary transfer device 26 in cooperation with the inner secondary transfer roller 23 as an opposing member (opposing electrode). The outer secondary transfer roller 25 is pressed toward the inner secondary transfer roller 23, and contacts the inner secondary transfer roller 23 by way of the intermediary transfer belt 6 and forms a secondary transfer portion (secondary transfer nip) N2 which is a contact portion between the intermediary transfer belt 6 and the outer secondary transfer roller 25. The toner image formed on the intermediary transfer belt 6 is transferred (secondarily transferred) onto the recording material S, nipped and fed by the intermediary transfer belt 6 and the outer secondary transfer roller 25, by the action of the secondary transfer device 26 in the secondary transfer portion N2. To the outer secondary transfer roller 25, a secondary transfer power source 76 (FIG. 2) as a secondary transfer voltage applying means (secondary transfer voltage applying portion) is connected. During the secondary transfer, the secondary transfer power source 76 applies a secondary transfer voltage (secondary transfer bias), which is a DC voltage having an opposite polarity (positive polarity in this embodiment) to the normal charge polarity of the toner to the outer secondary transfer roller 25. By this, the toner image formed with toner having the negative polarity on the intermediary transfer belt 6 is secondarily transferred onto the recording material S. To the secondary transfer power source 76, a voltage detecting sensor 76a (FIG. 2) as a voltage detecting means (voltage detecting portion) for detecting the output voltage thereof and a current detecting sensor 76b (FIG. 2) as a current detecting means (current detecting portion) for detecting the output current thereof are connected. Further, the core metal of the inner secondary transfer roller 23 is connected to the ground potential. In this embodiment, for example, a secondary transfer voltage of about 1 to 6.5 kV is applied to the outer secondary transfer roller 25, and a secondary transfer current of about 15 to 100 μA is caused to flow through the secondary transfer portion N2, so that the toner image on the intermediary transfer belt 6 is secondarily transferred onto the recording material S. In this embodiment, the secondary transfer voltage is subjected to constant-voltage control. Incidentally, a constitution in which to the inner secondary transfer roller 23, as the secondary transfer member, the secondary transfer voltage which is the DC voltage of the same polarity as the normal charge polarity of the toner is applied from the secondary transfer power source 76, so that the outer secondary transfer roller 25 as the opposing member is connected to the ground potential may also be employed.

The recording material S is fed from the feeding portion 4 toward the secondary transfer portion N2 in parallel to the forming operation of the toner image onto the intermediary transfer belt 6. The recording material S is accommodated in a cassette 41 as a recording material accommodating portion of the feeding portion 4. The recording material S accommodated in the cassette 41 is separated and fed one by one from the cassette 41 by a feeding roller 42 or the like. This recording material S is conveyed by a conveying roller 43 or the like as a conveying member of the feeding portion 4 to a registration roller pair 19 as a conveying member provided in a conveying passage 44 of the recording material S. Then, this recording material S is conveyed to the secondary transfer portion N2 by being timed to the toner image on the intermediary transfer belt 6 by the registration roller pair 19. Incidentally, in FIG. 1, only one cassette 41 is illustrated, but the image forming apparatus 1 may also include a plurality of cassettes 41. Further, the feeding portion 4 may be capable of feeding the recording material S also from a recording material accommodating portion (recording material mounting portion) other than the cassette 41, such as a manual feeding tray or the like.

Here, in this embodiment, the outer secondary transfer roller 25 includes a core metal and an elastic layer of an ion conductive foam rubber (NBR rubber) formed around the core metal. An outer diameter of the outer secondary transfer roller 25 is, for example, 20 to 25 mm. In addition, as the outer secondary transfer roller 25, a roller having an electric resistance value of 1×10⁵ to 1×10⁸Ω (measured at N/N (23° C., 50% RH), 2 kV applied) can be preferably used.

The recording material S onto which the toner image was transferred is fed to a fixing device 27 as a fixing means. The fixing device 27 includes a fixing roller 27a and a pressing roller 27b. The fixing roller 27a includes therein a heater as a heating means. The pressing roller 27b is press-contacted to the fixing roller 27a and thus forms a fixing portion (fixing nip). The fixing device 27 causes the recording material S carrying the unfixed toner image to be heated and pressed by nipping and feeding the recording material S between the fixing roller 27a and the pressing roller 27b, and thus causes the toner image to be fixed (melted, sticked) on the recording material S. Incidentally, the temperature of the fixing roller 27a (fixing temperature) is detected by a fixing temperature sensor 77 (FIG. 2). The recording material S on which the toner image was fixed is fed by a discharging roller pair 51 or the like, and is discharged (outputted) through a discharge opening (not shown), onto a discharge tray 52 provided outside an apparatus main assembly 1a of the image forming apparatus 1.

The surface of the photosensitive drum 11 after the primary transfer is electrically discharged by the pre-exposure device 16. In addition, toner remaining on the photosensitive drum 11 without being transferred onto the intermediary transfer belt 6 during the primary transfer (primary transfer residual toner) is removed from the surface of the photosensitive drum 11 by the drum cleaning device 17 and is collected. In this embodiment, the drum cleaning device 17 scrapes off the primary transfer residual toner from the surface of the rotating photosensitive drum 11 by a cleaning blade as a cleaning member, and collects the primary transfer residual toner in a collecting container (not shown). The cleaning blade is a plate-like member contacting the photosensitive drum 11 with a predetermined pressing force. The cleaning blade contacts the surface of the photosensitive drum 11 in a counter direction to the rotational direction of the photosensitive drum 11 so that a leading end thereof on a free end portion side faces the upstream side of the rotational direction of the photosensitive drum 11. Further, a deposited matter such as toner remaining on the intermediary transfer belt 6 without being transferred onto the recording material S during the secondary transfer (secondary transfer residual toner) or the like is removed and collected from the surface of the intermediary transfer belt 6 by a belt cleaning device 24 as an intermediary transfer member cleaning means.

Incidentally, the image forming unit 10 may constitute a cartridge (process cartridge) integrally detachably mountable to the apparatus main assembly 1a of the image forming apparatus 1. Further, in this embodiment, the intermediary transfer unit 20 is constituted by the intermediary transfer belt 6, the stretching rollers for the intermediary transfer belt 6, the respective primary transfer rollers 15, the belt cleaning device 24, and potential regulating members 8 and the like described later. The intermediary transfer unit 20 may be integrally detachably mountable to the apparatus main assembly 1a.

### 2. Control Constitution

Next, a constitution of a control system of the image forming apparatus 1 of this embodiment will be described. FIG. 2 is a block diagram showing a schematic constitution of the control system of the image forming apparatus 1 of this embodiment.

The image forming apparatus 1 is provided with the controller 3 (control circuit) as a control means. The controller 3 is constituted by including a CPU 31 as a calculating means, a ROM 32 as a storing means, a RAM 33 as a storing means, and an input/output circuit (I/F) (not shown) for inputting/outputting signals between itself and the external device. The ROM 32 stores programs or the like for controlling the respective portions of the image forming apparatus 1. The RAM 33 temporarily stores data on the control. The CPU 31 is a microprocessor which controls the entire image forming apparatus 1 and is a main part of a system controller. The CPU 31 is connected to the respective portions such as the feeding portion 4, the image forming portion 2, the discharge portion 5, and the like, and not only exchanges signals with these portions, but also controls the operation of each of these portions. The ROM 32 stores an image formation control sequence for forming the image on the recording material S.

To the controller 3, the charging power source 73, the developing power source 74, the primary transfer power source 75, the secondary transfer power source 76, and a potential regulating power source 80 described hereinafter, which are controlled by signals from the controller 3, respectively, are connected. Incidentally, although omitted from illustration, in this embodiment, each of the charging power source 73, the developing power source 74, the primary transfer power source 75, and the potential regulating power source 80 is provided independently of the associated image forming unit 10. In addition, to the controller 3, the temperature sensor 71, the humidity sensor 72, the voltage detecting sensor 75a and the current detecting sensor 75b of the primary transfer power source 75, the voltage detecting sensor 76a and the current detecting sensor 76b of the secondary transfer power source 76, and the fixing temperature sensor 77, and the like are connected. A signal (information) indicating a detection result of the associated sensor is inputted to the controller 3. Further, to the controller 3, an operating portion 70 is connected. Then operating portion 70 includes an input portion constituted by an operation button (key) or the like as an input means, and a display portion 70a constituted by a liquid crystal panel (display) or the like as display means. Incidentally, in this embodiment, the display portion 70a is constituted as a touch panel, and also has a function as the input means. An operator such as a user or a service person operates the operating portion 70 and thus can cause the image forming apparatus 1 to execute a job (a series of operations for forming and outputting an image on a single recording material S or images on a plurality of recording materials S by a single start instruction). The controller 3 receives the signal from the operating portion 70 and operates various devices of the image forming apparatus 1. In addition, the image forming apparatus 1 can also execute the job depending on the signal, for example, from the external device such as the personal computer, not from the operating portion 70.

### 3. Suppression of Electric Discharge Between Intermediary Transfer Belt and Photosensitive Drum

Next, the problem in suppression of electric discharge between the intermediary transfer belt 6 and the photosensitive drum 11 will be described. Incidentally, for convenience, unless otherwise mentioned, a magnitude (high/low) of a voltage and a potential refers to a magnitude (high/low) in the case where values thereof are compared with each other in terms of an absolute value. Further, as regards arrangements of the primary transfer portion N1, the photosensitive drum 11, the primary transfer roller 15, and the potential regulating member 8 described later, and the like, unless otherwise mentioned, upstream and downstream refer to upstream and downstream with respect to the feeding direction (process progression direction, movement direction) of the intermediary transfer belt 6.

As described above, in the image forming apparatus 1 of the intermediary transfer type, it is difficult to uniformly transfer the toner image on, for example, embossed paper with surface unevenness. Incidentally, the embossed paper is paper (fancy paper) provided with an uneven pattern by using a method such as swelling or stamping on the surface of the paper. Particularly, transfer of the toner image onto a recessed portion of the embossed paper requires a relatively large transfer electric field because a gap is formed between the intermediary transfer belt 6 and the embossed paper in the secondary transfer portion N2, and thus is liable to become difficult. Further, when a secondary transfer electric field is made large for improving a transfer property of the toner image onto the recessed portion of the embossed paper, in the case where the transfer electric field becomes excessively large at a portion other than the recessed portion, there is a possibility that improper transfer such that the toner is not partially transferred onto a half-tone image occurs.

The toner on the intermediary transfer belt 6 is subjected to electric discharge between the intermediary transfer belt 6 and the photosensitive drum 11 on a side downstream of the primary transfer portion N1 and thus a charge amount of the toner increases. Specifically, the toner is subjected to the electric discharge and thus there is a tendency that an average of the charge amount of the toner is increased while a toner charge amount distribution becomes broader than a toner charge amount distribution during the development. In addition, due to the increase in charge amount, a mirror force between the toner and the intermediary transfer belt 6 increases and a transfer electric field necessary to transfer the toner onto the recording material S in the secondary transfer portion N2 becomes large, and thus it becomes further difficult to transfer the toner image onto the recessed portion of the embossed paper.

That is, when the above-described electric discharge can be suppressed, the increase in charge amount of the toner on the intermediary transfer belt 6 is suppressed, so that a transfer property of the toner image onto the recording material S, such as the embossed paper, onto which transfer of the toner image is relatively difficult can be improved. In order to suppress the above-described electric discharge, it is effective that a potential difference between the photosensitive drum 11 and the intermediary transfer belt 6 after the toner image passes through the primary transfer portion N1 is made small. Further, for that purpose, it is effective that a potential regulating member 8 which is an electrode member is provided on an inner peripheral surface (back surface) side of the intermediary transfer belt 6 in a position downstream of the primary transfer portion N1 and that a voltage of the same polarity as the charge polarity of the photosensitive drum 11 is applied to the potential regulating member 8. Particularly, the above-described electric discharge can be more effectively suppressed by disposing the potential regulating member 8 in contact with the inner peripheral surface of the intermediary transfer belt 6 and by applying the voltage of the same polarity as the charge polarity of the photosensitive drum 11 to the potential regulating member 8.

Further, the above-described electric discharge occurs in a range of about 0.3 to 1.5 mm from the primary transfer portion N1 toward a downstream side in many cases. On the other hand, it would be considered that by applying the voltage of the same polarity as the charge polarity of the photosensitive drum 11 to the potential regulating member 8, the above-described electric discharge can be suppressed by the action of an electric field formed in a space between the photosensitive drum 11 and the potential regulating member 8. Further, the above-described electric discharge suppressing effect is larger in the case where the potential regulating member 8 is surface-contacted to the intermediary transfer belt 6 with a width with respect to the feeding direction of the intermediary transfer belt 6 than in the case where the potential regulating member 8 is point (line)-contacted to the intermediary transfer belt 6 with respect to the feeding direction of the intermediary transfer belt 6. Further, by bringing the potential regulating member 8 into surface contact with the intermediary transfer belt 6, a contact state between the intermediary transfer belt 6 and the potential regulating member 8 can be stabilized. This would be considered that an electrostatic adsorption force acts between the intermediary transfer belt 6 and the potential regulating member 8. Accordingly, it is more preferable that the potential regulating member 8 is surface-contacted to the intermediary transfer belt 6. Here, the surface contact (contact at the surface) means that the contact does not include the case where the potential regulating member 6 is contacted to the intermediary transfer belt 6 only in a line shape with respect to a direction crossing the feeding direction of the intermediary transfer belt 6 in a range narrower than a contact width (about 5 to 50 mm) as described specifically hereinafter. Accordingly, the surface contact includes, for example, not only the case where a substantially entire region of the potential regulating member 8 is continuously and closely contacted to the intermediary transfer belt 6 in a region of the contact width described specifically hereinafter but also the case where may contact points are distributed substantially uniformly in the above-described range as in the case of a nonwoven fabric or the like. In the following, description will be made further specifically.

### 4. Potential Regulating Member

Next, a constitution of the potential regulating member 8 will be described. As shown in FIG. 1, the image forming apparatus 1 of this embodiment, on sides downstream of the primary transfer portions N1y, N1m, N1c, and N1k, the potential regulating members 8y, 8m, 8c, and 8k which are electrode members are provided, respectively, in contact with the inner peripheral surface of the intermediary transfer belt 6. In this embodiment, the potential regulating members 8y, 8m, 8c, and 8k provided in the primary transfer portions N1y, N1m, N1c, and N1k have the substantially same constitution.

A shape of the potential regulating member 8 in this embodiment will be described. Part (a) of FIG. 3 is a schematic sectional view (cross section substantially perpendicular to a rotational axis direction of the photosensitive drum 11) of an example of the potential regulating member 8 in this embodiment, and part (b) of FIG. 3 is a schematic perspective view of the potential regulating member 8.

In this embodiment, the potential regulating member 8 includes a planar first portion 81 provided along a widthwise direction (direction substantially perpendicular to the feeding direction, direction substantially parallel to the rotational axis direction of the photosensitive drum 11) of the intermediary transfer belt 6. Further, in this embodiment, the potential regulating member 8 includes a planar second portion 82 provided along the widthwise direction of the intermediary transfer belt 6 and extending in a direction crossing (in this embodiment, substantially perpendicular to) a flat surface of the first portion 81. In this embodiment, a contact surface 83 of the first portion 81 of the potential regulating member 8, which is a contact portion contacting the inner peripheral surface of the intermediary transfer belt 6 is a flat surface. That is, in this embodiment, the first portion 81 constituting the contact surface 83 of the potential regulating member 8 is a flat plate. Thus, in this embodiment, the potential regulating member 8 is constituted by a substantially L-shaped member in cross section substantially perpendicular to the rotational axis direction of the photosensitive drum 11.

Here, in the cross section substantially perpendicular to the rotational axis direction of the photosensitive drum 11, an upstream-side end portion of the contact surface 83 is defined as “A (or upstream end A)”, and a downstream-side end portion of the contact surface 83 is defined as “B (or downstream end B)”. In this embodiment, the upstream end A of the contact surface 83 corresponds to an upstream-side end portion of the potential regulating member 8, and the downstream end B of the contact surface 83 corresponds to a downstream-side end portion of the potential regulating member 8. As described above, by the action of the electric field formed in the space between the photosensitive drum 11 and the potential regulating member 8, in order to more effectively suppress the electric discharge between the intermediary transfer belt 6 and the photosensitive drum 11, the potential regulating member 8 may preferably be surface-contacted to the intermediary transfer belt 6. As a result, as regards a potential regulating voltage in the constitution of this embodiment, a length of a line segment AB (between A and B), i.e., a “contact width” which is a length of the contact surface 83 in the feeding direction of the intermediary transfer belt 6 may preferably be 5 mm or more. As described later, in the constitution of this embodiment, the potential regulating voltage may preferably be about −500 to −8000 V, more preferably about −1000 to −5000 V. With a longer length of the line segment AB, the above-described effect of suppressing the electric field becomes larger, but it would be considered that when the length becomes excessively long, stable contact of the potential regulating member 8 with the intermediary transfer belt 6 becomes difficult by the influence of (component) part accuracy or the like. The length of the line segment AB is sufficient in many cases when the length is 50 mm or less, and typically is 30 mm or less. That is, the length of the line segment AB may suitably be about 5 to 50 mm, typically about 5 to 30 mm. From another viewpoint, it can be said that the length of the line segment AB is enough to be not more than a half of a center distance between adjacent photosensitive drums 11 in a cross section substantially perpendicular to the rotational axis direction of the photosensitive drum 11 in many cases. In this embodiment, the potential regulating member 8 which is 25 mm in length of the line segment AB is used. Incidentally, in this embodiment, the center distance between the photosensitive drums 11 in the cross section substantially perpendicular to the rotational axis direction of the photosensitive drum 11 is about 100 mm.

To the potential regulating member 8, the potential regulating power source 80 as a potential regulating voltage applying means (potential regulating voltage applying portion) is connected. In this embodiment, to the second portion 82 of the potential regulating member 8, the potential regulating power source 80 is connected. At least at the time of the primary transfer during the image forming operation, to the potential regulating member 8, a potential regulating voltage (potential regulating bias) which is a DC voltage of the same polarity as the charge polarity of the photosensitive drum 11 is applied by the potential regulating power source 80. The time of the primary transfer is specifically a period in which the primary transfer voltage is applied, a period in which an image region (region onto which the toner image is capable of being transferred) on the intermediary transfer belt 6 passes through the primary transfer portion N1. By this, it is possible to suppress the electric discharge between the intermediary transfer belt 6 and the photosensitive drum 11 on a side downstream of the primary transfer portion N1. In this embodiment, the potential regulating voltage is a DC voltage of a negative polarity. Further, in the constitution of this embodiment, the potential regulating voltage may preferably be about −500 to −8000 V, more preferably be about −1000 to −5000 V, typically about −1000 to −3000 V.

The potential regulating member 8 is a member long in the widthwise direction of the intermediary transfer belt 6. A length of the contact surface 83 of the potential regulating member 8 in a longitudinal direction (direction along the widthwise direction of the intermediary transfer belt 6 may preferably be longer than a maximum image width in the widthwise direction of the intermediary transfer belt 6. Incidentally, the maximum image width is a length of an image region of a maximum image capable of being formed by the image forming apparatus 1 with respect to the widthwise direction of the intermediary transfer belt 6. In this embodiment, the length of the contact surface 83 of the potential regulating member 8 in the longitudinal direction is longer than the above-described maximum image width and a width of a portion in which the primary transfer roller 15 contacts the intermediary transfer belt 6 with respect to the widthwise direction of the intermediary transfer belt 6. That is, in this embodiment, each of a range of the maximum image width and a range of the width of the portion in which the primary transfer roller 15 contacts the intermediary transfer belt 6 with respect to the widthwise direction of the intermediary transfer belt 6 falls inside a range of the length of the contact surface 83 of the potential regulating member 8 in the longitudinal direction. By this, irrespective of a length of the toner image, transferred onto the intermediary transfer belt 6, with respect to the widthwise direction of the intermediary transfer belt 6, it is possible to obtain an effect of suppressing an increase in charge amount of the toner on the intermediary transfer belt 6 by suppressing the above-described electric charge. On the other hand, in this embodiment, the length of the potential regulating member 8 in the longitudinal direction is shorter than the width of the intermediary transfer belt 6. That is, in this embodiment, the range of the length of the potential regulating member 8 in the longitudinal direction falls inside the range of the width of the intermediary transfer belt 6. By this, it is possible to suppress the electric discharge, between the potential regulating member 8 and a peripheral member or the like of the intermediary transfer belt 6, capable of occurring in the case where an end portion of the potential regulating member 8 with respect to the longitudinal direction protrudes than an end portion of the intermediary transfer belt 6 with respect to the widthwise direction is. As a result, it is possible to reduce a possibility that the effect of suppressing the electrical discharge between the intermediary transfer belt 6 and the photosensitive drum 11 by the potential regulating member 8 becomes small.

The potential regulating member 8 can be constituted only by, for example, a single material having electroconductivity. In this embodiment, the potential regulating member 8 is constituted substantially only by metal having electroconductivity, such as SUS (stainless steel). Specifically, in this embodiment, the potential regulating member 8 is constituted by forming the first portion 81 and the second portion 82 by subjecting a plate material made of metal (metal plate) such as SUS to bending. A thickness of the metal plate used for the potential regulating member 8 may be, for example, about 0.5 to 5 mm, typically is about 1 to 3 mm. By thus subjecting the metal plate to the bending, strength of the potential regulating member 8 can be increased. In this embodiment, each of the first portion 81 and the second portion 82 of the potential regulating member 8 is not substantially deformed in a use state of the image forming apparatus 1. However, the present disclosure is not limited to such an embodiment, but the potential regulating member 8 may also be constituted by two or more materials.

Incidentally, the electroconductive material (electroconductor) refers to a material (substance) of which resistivity is about 10⁻⁶ Ω·cm or less, typically about 10⁻⁸ Ω·m. Further, a non-electroconductive material (insulator) refers to a material (substance) of which resistance value is 10⁸ Ω·m or more, preferably 10¹⁰ Ω·m or more. However, the insulator is 10¹⁶ Ω·m or less in resistivity.

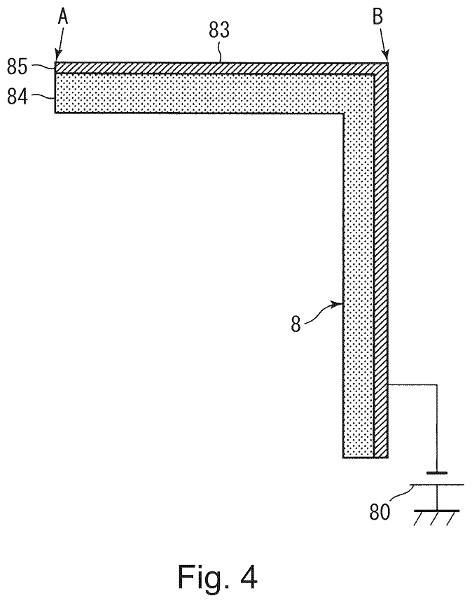

FIG. 4 is a schematic sectional view (cross section substantially perpendicular to the rotational axis direction of the photosensitive drum 11) in another example of the potential regulating member 8 in this embodiment. For example, as shown in FIG. 4, a constitution in which a base portion 84 having a shape similar to the shape of the potential regulating member 8 shown in FIG. 3 and a surface layer 85 formed on the base portion 84 are provided can be employed. The contact surface 83 contacting the intermediary transfer belt 6 and the surface layer 85 constituting a connecting portion with the potential regulating power source 80 are formed of an electroconductive material such as metal or an electroconductive resin material.

The surface layer 85 may also have a constitution which is the same constitution as the constitution of the potential regulating member 8 shown in FIG. 3. The base portion 84 may be formed of the electroconductive material, but may also be formed of a non-electroconductive (electrically insulative) material, for example, a non-electroconductive resin material. The base portion 84 and the surface layer 85 can be fixed by an arbitrary fixing means such as bonding with an adhesive or welding.

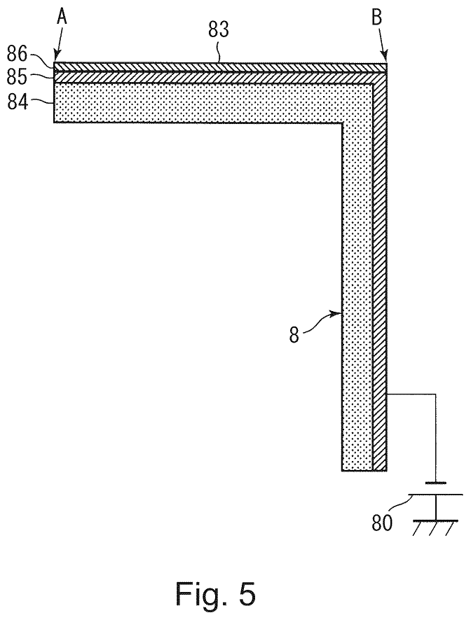

Further, FIG. 5 is a schematic sectional view (cross section substantially perpendicular to the rotational axis direction of the photosensitive drum 11) in still another example of the potential regulating member 8 in this embodiment. For example, as shown in FIG. 5, the contact surface 83 of the potential regulating member 8 contacting the intermediary transfer belt 6 may also be formed of an electroconductive nonwoven fabric 86. Incidentally, in an example shown in FIG. 5, the electroconductive nonwoven fabric 86 is provided on the contact surface 83 of the potential regulating member 8 having the constitution shown in FIG. 4, but may also be provided on the contact surface 83 of the potential regulating member 8 having the constitution shown in FIG. 3. That is, the potential regulating member 8 may be formed by using other materials for the base portion to which the voltage is applied and the surface layer contacting the inner peripheral surface of the intermediary transfer belt 6. The electroconductive nonwoven fabric 86 can be fixed by an arbitrary fixing means such as an electroconductive adhesive. Further, instead of the nonwoven fabric 86, a felt, a pile fabric (cut pile fabric (velvet, brush) or loop pile fabric (toweling)) which are constituted using electroconductive fibers, or a sponge (elastic foam member) constituted using an electroconductive rubber material may also be used. Thus, the contact surface 83 of the potential regulating member 8 contacting the intermediary transfer belt 6 is constituted by a flexible material or an elastic material, so that it is possible to reduce a possibility of an occurrence of scars on an inner peripheral surface of the intermediary transfer belt 6 caused by friction (slide) between the inner peripheral surface of the intermediary transfer belt 6 and the potential regulating member 8.

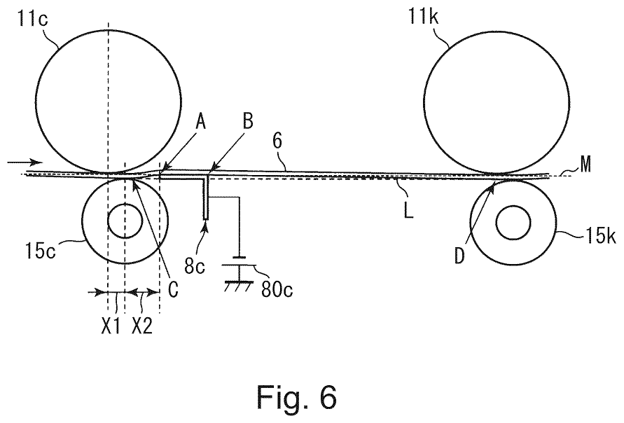

Next, an arrangement of the potential regulating member 8 will be described. In this embodiment, the arrangement of the potential regulating member 8 provided for each of the primary transfer portions N1y, N1m, N1c, and N1k is substantially the same. FIG. 6 is a schematic sectional view (cross section substantially perpendicular to the rotational axis direction of the photosensitive drum 11) for illustrating the arrangement of the potential regulating member 8 provided between two primary transfer portions N1 adjacent to each other in the feeding direction of the intermediary transfer belt 6. In FIG. 5, as an example, a potential regulating member 8c provided between the primary transfer portions N1c for cyan and N1k for black is shown.

In this embodiment, an outer diameter of the photosensitive drum 11 is 30 mm, an outer diameter of the primary transfer roller 15 is 18 mm, and a thickness of the intermediary transfer belt 6 is 0.350 mm. Further, in this embodiment, the primary transfer roller 15 is offset toward a downstream side relative to the photosensitive drum 11. In this embodiment, an offset amount X1 is 3 mm. Incidentally, the offset amount X1 is a distance between a rotation center of the photosensitive drum 11 and a rotation center of an associated primary transfer roller 15 in a direction along (substantially parallel to) a common tangential line on a side where a plurality of photosensitive drums 11 contact the intermediary transfer belt 6 in a cross section substantially perpendicular to the longitudinal direction of the photosensitive drum 11. Further, the primary transfer roller 15 may be disposed without being offset relative to the photosensitive drum 11 and may also be disposed so as to be offset toward an upstream side relative to the photosensitive drum 11.

Here, in order to illustrate the arrangement of the potential regulating member 8, the case where the potential regulating member 8 is removed is assumed. In the cross section substantially perpendicular to the rotational axis direction of the photosensitive drum 11, a rectilinear line along which a stretching surface of the intermediary transfer belt on an inner peripheral surface side in a portion downstream of the primary transfer portion N1 passes in the case where there is no potential regulating member 8 is defined as a rectilinear line L. Incidentally, specifically, this rectilinear line L corresponds to the stretching surface in a state in which only the potential regulating member 8 is substantially removed from the constitution of the image forming apparatus 1 in a state during the image forming operation (however, the photosensitive drum 11 and the intermediary transfer belt 6 are at rest). That is, the rectilinear line L corresponds to the above-described stretching surface in a state in which a stretching state of the intermediary transfer belt 6 is an image formable stretching state (such that the toner image is capable of being primarily transferred from the photosensitive drum 11 onto the intermediary transfer belt 6) and in which the intermediary transfer belt 6 is at rest (stationary). Further, on the rectilinear line L, a portion where the inner peripheral surface of the intermediary transfer belt 6 is separated from a closest stretching member on an upstream side of the potential regulating member 8 is defined as “C (or upstream stretching portion C)”, and a portion where the inner peripheral surface of the intermediary transfer belt 6 is separated from a closest stretching member on a downstream side of the potential regulating member 8 is defined as “D (or downstream stretching portion D)”. Incidentally, in FIG. 6, the rectilinear line L is schematically shown substantially horizontally, but in the case where the surface of the primary transfer roller 15 is raised toward the photosensitive drum 11 side by deformation or the like of the elastic layer of the primary transfer roller 15, the rectilinear line L may be inclined downward toward the downstream side in FIG. 6.

In this embodiment, the closest stretching member on the upstream side of the potential regulating member 8 is the primary transfer roller 15, and a position on the inner peripheral surface of the intermediary transfer belt 6 at a portion where the intermediary transfer belt 6 is separated from the primary transfer roller 15 is the upstream stretching portion C. However, the closest stretching member on the upstream side of the potential regulating member 8 is not limited to the primary transfer roller 15. For example, in the case where the primary transfer roller 15 is offset and disposed on an upstream side relative to the photosensitive drum 11, a position on the inner peripheral surface of the intermediary transfer belt 6 at a portion corresponding to a portion where the intermediary transfer belt 6 is separated from the photosensitive drum 11 is the upstream stretching portion C.

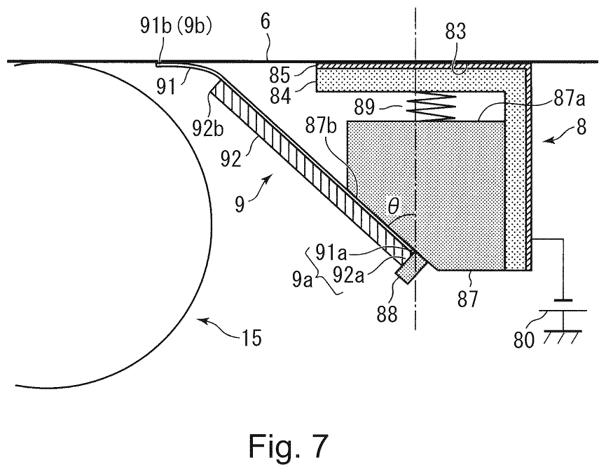

Further, in this embodiment, the closest stretching member on the downstream side of the potential regulating member 8 is the photosensitive drums 11m, 11c, and 11k disposed adjacent to the potential regulating member 8 on the downstream side of the potential regulating member 8 for the primary transfer portions N1y, N1m, and N1c, respectively, for yellow, magenta, and cyan. Further, a position on the inner peripheral surface of the intermediary transfer belt 6 at a portion corresponding to a portion where the intermediary transfer belt 6 is separated from an associated one of the photosensitive drums 11m, 11c, and 11k is the downstream stretching portion D. However, the closest stretching member on the downstream side of the potential regulating member 8 is not limited to the photosensitive drum 11. For example, as shown in FIG. 7, in the case where the primary transfer roller 15 is offset and disposed on the upstream side relative to the photosensitive drum 11, a position on the inner peripheral surface of the intermediary transfer belt 6 at a portion where the intermediary transfer belt 6 is separated from the primary transfer roller 15 is the downstream stretching portion D. Further, in this embodiment, for the most downstream primary transfer portion Nik for black, the closest stretching member on the downstream side thereof is the stretching roller (tension roller in this embodiment) 22. Further, a position on the inner peripheral surface of the intermediary transfer belt 6 at a portion where the intermediary transfer belt 6 is separated from the stretching roller 22 is the downstream stretching portion D.

As shown in FIG. 6, the potential regulating member 8 is disposed close to the primary transfer portion N1 on a side downstream of the primary transfer portion N1 so as not to contact the primary transfer roller 15 and the photosensitive drum 11 via the intermediary transfer belt 6. At this time, as the upstream end A is closer to the primary transfer portion N1, the effect of suppressing the electric charge between the intermediary transfer belt 6 and the photosensitive drum 11 by the potential regulating member 8 becomes larger. In this embodiment, the potential regulating member 8 is disposed in a position downstream of the primary transfer portion N1 so that a distance X2 from the primary transfer roller 15 to the upstream end A becomes about 8 mm. Here, the distance X2 is a distance between the rotation center of the primary transfer roller 15 and the upstream end A in a direction along (substantially parallel to) the common tangential line on a side where the plurality of photosensitive drums 11 contact the intermediary transfer belt 6 in the cross section substantially perpendicular to the rotational axis direction of the photosensitive drum 11.

That is, in this embodiment, the distance from the rotation center of the primary transfer roller 15 to the upstream end A is shorter than a distance (radius) from the rotation center of the primary transfer roller 15 to an outer circumference of the primary transfer roller 15. This distance is not limited thereto, but the above-described distance X2 may preferably be about 1 to 20 mm, typically about 1 to 10 mm.

Further, in this embodiment, the potential regulating member 8 is pressed against the inner peripheral surface of the intermediary transfer belt 6 by a pressing spring 89 (FIG. 7) constituted by a compression coil spring which is an urging member as an urging means at each of opposite end portions thereof with respect to the longitudinal direction thereof. At this time, the contact portion of the potential regulating member 8 contacting the inner peripheral surface of the intermediary transfer belt 6 is caused to enter the photosensitive drum 11 side relative to the rectilinear line L. By this, even in the case where waving or vibration occurs on the intermediary transfer belt 6 during the image forming operation (during traveling of the intermediary transfer belt 6), the potential regulating member 8 can be more stably contacted to the intermediary transfer belt 6. In this embodiment, a pressing force of the pressing spring 89 is set (adjusted) so that the upstream end A and the downstream end B of the contact surface 83 of the potential regulating member 8 are caused to enter the photosensitive drum 11 side relative to the rectilinear line L by about 0.5 mm. Thus, the contact surface 83 of the potential regulating member 8 is caused to enter the photosensitive drum 11 side relative to the rectilinear line L, whereby even in the case where the warning or the vibration occurs on the intermediary transfer belt 6 during the image forming operation (during the traveling of the intermediary transfer belt 6, the potential regulating member 8 can be more stably surface-contacted to the intermediary transfer belt 6. Although the potential regulating member 8 is not limited thereto, an entering amount of the contact surface 83 of the potential regulating member 8 into the rectilinear line L may preferably be about 0.3 to 5 mm, more preferably about 0.5 to 3 mm, typically about 0.5 to 1.0 mm. When this entering amount is excessively small, there is a possibility that stable contact of the potential regulating member 8 to the intermediary transfer belt 6 becomes difficult. When the entering amount is excessively large, there is a possibility that stable feeding (conveyance) of the intermediary transfer belt 6 becomes difficult and that the electric discharge between the intermediary transfer belt 6 and the photosensitive drum 11 increases.

Here, in the cross section substantially perpendicular to the rotational axis direction of the photosensitive drum 11, a rectilinear line passing through the upstream end A and the downstream end B of the contact surface 83 is defined as a rectilinear line M. At this time, it is preferable that the rectilinear line M is prevented from crossing a line segment CD of the rectilinear line L. By this, in the case where the contact surface 83 of the potential regulating member 8 is a flat surface, the intermediary transfer belt 6 and the potential regulating member 8 can be surface-contacted to each other more reliably. In the case where the rectilinear line M crosses the line segment CD of the rectilinear line L, there is a possibility that only either one of an end portion of the potential regulating member 8 on the upstream end A side and an end portion of the potential regulating member 8 on the downstream end B side can contact the inner peripheral surface of the intermediary transfer belt 6. In this case, there is a possibility that it becomes difficult to enhance the discharge suppressing effect by the surface-contact. Further, in FIG. 6, the potential regulating member 8 is disposed so that the rectilinear line M and the rectilinear line L are substantially parallel to each other, but when the rectilinear line M falls within a range in which the rectilinear line M does not cross the line segment CD of the rectilinear line L, the potential regulating member 8 may be disposed so that the rectilinear line M is inclined relative to the rectilinear line L.

Incidentally, the contact portion of the potential regulating member 8 contacting the inner peripheral surface of the intermediary transfer belt 6 is not limited to the flat surface. For example, the potential regulating member 8 is constituted by a bent plate of which cross section substantially perpendicular to the rotational axis direction of the photosensitive drum 11 is bent in a convexly curved line shape toward the photosensitive drum 11 side, and the contact portion of the potential regulating member 8 contacting the inner peripheral surface of the intermediary transfer belt 6 may also be a curved surface convexly toward the photosensitive drum 11 side. Thus, the contact portion (contact side) of the potential regulating member 8 contacting the inner peripheral surface of the intermediary transfer belt 6 is formed in a curved surface shape, so that stress when the potential regulating member 8 rubs the intermediary transfer belt 6 can be reduced. By using a roller-shaped potential regulating member 8, the contact portion of the potential regulating member 8 contacting the inner peripheral surface of the intermediary transfer belt 6 may also be formed as a curved surface.

Further, in this embodiment, as the recording material S relatively difficult in transfer of the toner image thereon, the embossed paper was cited as an example, but a similar effect can be expected also on a recording material relatively high in electric resistance (high-resistance paper), such as synthetic paper or a resin film, which principally comprises a synthetic resin material.

### 5. Suppression of Electric Discharge Between Primary Transfer Roller and Potential Regulating Member

Next, suppression of electric discharge between the primary transfer roller and the potential regulating member will be described.

As described above, the potential regulating member 8 is brought rear to the primary transfer portion N1 as can as possible, and a relatively high bias of the same polarity as the charge polarity of the photosensitive drum is applied, so that a larger effect is achieved.

However, the bias, applied to the potential regulating member 8, of the same polarity as the charge polarity of the photosensitive drum 11 is opposite in polarity to the bias applied to the primary transfer roller 15. For that reason, in the case where the potential regulating member 8 is disposed close to the primary transfer portion N1 and the bias applied to the potential regulating member 8 is made high or in the like case, a large potential difference generates between the potential regulating member 8 and the primary transfer roller 15. Then, by this potential difference, there is a possibility that electric discharge (abnormal electric discharge, leakage) through a space between the potential regulating member 8 and the primary transfer roller 15 is generated. In general, in order to sufficiently suppress the electric discharge through the space, it is desired that a space distance of 3 mm per 1 kV of the potential difference is provided. In the case where such a space distance is not ensured, there is a possibility that the electric discharge through the space is generated between the potential regulating member 8 and the primary transfer roller 15. In addition, there is a possibility that an effect of suppressing the electric discharge between the intermediary transfer belt 6 and the photosensitive drum 11 by the potential regulating member 8 lowers. Further, a possibility that primary transfer is influenced would be considered. In addition, a possibility that the potential regulating member 8 and the primary transfer roller 15 are damaged would also be considered.

For example, in the case where the primary transfer voltage applied to the primary transfer roller 15 is +2 kV and the potential regulating voltage applied to the potential regulating member 8 is −2 kV, the potential difference between the primary transfer roller 15 and the potential regulating member 8 is 4 kV. In this case, in order to sufficiently suppress the electric discharge through the space between the primary transfer roller 15 and the potential regulating member 8, it is desired that a space distance of 12 mm is provided. Further, in the case where such a space distance is not ensured, there is a possibility that the electric discharge through the space between the primary transfer roller 15 and the potential regulating member 8 is generated.

Therefore, in this embodiment, the image forming apparatus 1 is caused to have a constitution including a shielding member for electrically shielding the space between the potential regulating member 8 and the primary transfer roller 15.

### 6. Shielding Member

### 6-1. Structure of Shielding Member

Next, the shielding member in this embodiment will be described. FIG. 7 is a schematic sectional view, for illustrating a shielding member 9 in this embodiment, in the neighborhood of the primary transfer portion N1.

Incidentally, in this embodiment, structures and arrangement of the potential regulating member 8 and the shielding member 9 provided in the primary transfer portions N1y, N1m, Nic, and Nik are substantially the same. Further, in this embodiment, the potential regulating member 8 includes, as described with reference to FIG. 4, the base portion 84 and the surface layer 85 provided on the surface of the base portion 84, and the base portion 84 is formed of a non-electroconductive material and the surface layer 85 is formed of an electroconductive material (a metal plate or the like).

In this embodiment, the image forming apparatus 1 is provided with the shielding member 9, formed of the non-electroconductive material, for electrically shielding the space between the potential regulating member 8 and the primary transfer roller 15. At least as viewed substantially parallel to the widthwise direction of the intermediary transfer belt 6 (i.e., in a cross section substantially perpendicular to the rotational axis direction of the photosensitive drum 11), the shielding member 9 is provided in a region extending across a rectilinear line drawn so as to connect between the primary transfer roller 15 and the potential regulating member 8 (an electroconductive portion (the surface layer 85 in this embodiment) in a shortest distance. In this embodiment, the shielding member 9 is constituted by an elastically deformable elastic member and is provided so as to contact the inner peripheral surface of the intermediary transfer belt 6. In the following, description thereof will be made further specifically.

When the potential regulating member 8 is disposed close to the primary transfer portion N1, the space between the potential regulating member 8 and the primary transfer roller 15 becomes narrow. For that reason, in this embodiment, as the shielding member 9, a sheet-like member having an electrically insulative performance and elasticity (flexibility) is used. This sheet-like shielding member 9 is provided so that one side surface thereof faces a primary transfer roller 15 side and the other side surface faces a potential regulating member 8 side. In this embodiment, the shielding member 9 is constituted by including a first sheet 91 and a second sheet 92 formed with different materials.

The first sheet 91 is formed with material lower in rigidity than the second sheet 92. The first sheet 91 projects toward an inner peripheral surface side of the intermediary transfer belt 6 at a free end thereof relative to the second sheet 92, and is disposed so as to contact the inner peripheral surface of the intermediary transfer belt 6. In this embodiment, the first sheet 91 is formed with a sheet made of a resin having an electrically insulative property in a thickens of about 50 m. Specifically, in this embodiment, the first sheet 91 is formed using a sheet (“SPERIO (registered trademark)” F series, manufactured by Mitsubishi Chemical Corporation) which is a polyetherimide sheet. However, the material constituting the first sheet 91 is not limited to the material used in this embodiment, it is possible to appropriately select and use a material (typically, a resin material) having sufficiently low rigidity and a sufficiently high electrically insulative property.

On the other hand, the second sheet 92 is formed with the material high in rigidity than the first sheet 91. The second sheet 92 is disposed superposedly on a surface of the first sheet 91 on a side opposite from the intermediary transfer belt 6 side, and functions as a reinforcing member for the first sheet 91. Thus, in this embodiment, the shielding member 9 is lower in rigidity in a first region on a free end side (9b side) thereof than in a second region on a base end side (9a side) thereof. In this embodiment, the second sheet 92 is formed with a sheet made of an electrically insulative property in a thickness of about 200 μm. Specifically, in this embodiment, the second sheet 92 is formed using a sheet (“Lumirror (registered trademark)”, manufactured by Toray Industries, Inc.) which is a PET (polyethylene terephthalate) resin sheet. However, a material constituting the second sheet 92 is not limited to the material used in this embodiment, it is possible to appropriately select and use a material (typically, a resin material) having a sufficiently high rigidity and a sufficiently high electrically insulative property. Incidentally, the second sheet 92 is not limited to a sheet constituted by a material having the electrically insulative property. The second sheet 92 can be constituted so as to function at least as the reinforcing material for the first sheet 91, and may also be constituted by a material having electroconductivity.

The first sheet 91 is constituted by a substantially rectangular sheet-like member in plan view in a state in which the first sheet 91 is not deformed by an external force. The first sheet 91 has a predetermined length in each of a longitudinal direction disposed along (in this embodiment, substantially parallel to) a longitudinal direction of the potential regulating member 8 (widthwise direction of the intermediary transfer belt 6) and a short(-side) direction substantially perpendicular to the longitudinal direction. Further, the first sheet 91 is fixed to a base 87 described later in a part of a region on a base end 91a side which is one end portion with respect to the short direction and contacts the inner peripheral surface of the intermediary transfer belt 6 from a free end 91b in a part of a region on the free end 91b side which is the other end portion with respect to the short direction.

Further, the second sheet 92 is constituted by a substantially rectangular sheet-like member in plan view in a state in which the first sheet 91 is not deformed by an external force. The second sheet 92 has a predetermined length in each of a longitudinal direction disposed along (in this embodiment, substantially parallel to) a longitudinal direction of the potential regulating member 8 (widthwise direction of the intermediary transfer belt 6) and a short(-side) direction substantially perpendicular to the longitudinal direction. Further, the second sheet 92 is fixed to a base 87 described later in a part of a region on a base end 92a side which is one end portion with respect to the short direction and is disposed close to the inner peripheral surface of the intermediary transfer belt 6 at a free end 92b side which is the other end portion with respect to the short direction.

The first sheet 91 and the second sheet 92 can be fixed (bonded) by an arbitrary fixing means such as bonding with an adhesive, welding, or fixing with a double-side tape, at least in parts thereof, respectively. However, each of the first sheet 91 and the second sheet 92 may be not only fixed to the base 87 described later, but also may be provided so as to simply superposed on each other. The first sheet 91 projects toward the inner peripheral surface side of the intermediary transfer belt 6 relative to the free end 92b of the second sheet 92 in a part of the region thereof on the free end 91b side with respect to the short direction. In other words, the first sheet 91 is superposed on the second sheet 92 in a part of a region from the base end 91a toward the free end 91b side with respect to the short direction. Further, the first sheet 91 contacts the inner peripheral surface of the intermediary transfer belt 6 at least in a part of a region projecting from the second sheet 92.

Incidentally, in this embodiment, one end portion of the shielding member 9, with respect to the short direction, constituted by the base end 91a of the first sheet 91 and the base end 92a of the second sheet 92 may also be referred to as the base end 9a of the shielding member 9. Further, in this embodiment, the other end portion of the shielding member 9, with respect to the short direction, constituted by the free end 91b of the first sheet 91 may also be referred to as the free end 9b of the shielding member 9.

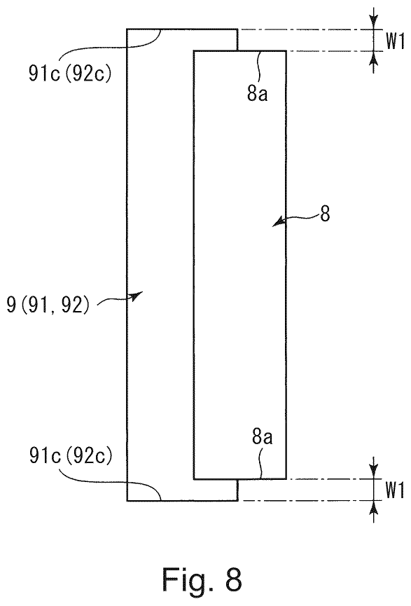

Further, in this embodiment, in order to ensure a space distance between the end portion of the potential regulating member 8 with respect to the longitudinal direction and the end portion of the primary transfer roller 15 with respect to the longitudinal direction, the length of the shielding member 9 in the longitudinal direction is made longer than the length of the potential regulating member 8 in the longitudinal direction. FIG. 8 is a schematic plan view in which the potential regulating member 8 and the shielding member 9 are viewed along a direction substantially perpendicular to the inner peripheral surface of the intermediary transfer belt 6. In this embodiment, the length of the first sheet 91 with respect to the longitudinal direction and the length of the second sheet 92 with respect to the longitudinal direction are substantially the same, and each of the lengths of the first sheet 91 and the second sheet 92 in the longitudinal direction is made longer than the length of the potential regulating member 8 in the longitudinal direction. By this, with respect to the longitudinal direction of the potential regulating member 8, each of opposite end portions 91c and 91c of the first sheet 91 and opposite end portions 92c and 92c of the second sheet 92 projects outward relative to each of associated opposite end portions 8a and 8a of the potential regulating member 8 (portion having electroconductivity (in this embodiment, the surface layer 85a)). The length of the shielding member 9 in the longitudinal direction may only be required to be set so as to satisfy a condition such that a space distance of, for example, 3 mm per 1 kV of the potential difference as described above, and can be calculated on the basis of a voltage applied to the primary transfer roller 15 and a voltage applied to the potential regulating member 8. In this embodiment, the length of the shielding member 9 in the longitudinal direction is a length in which each of opposite end portions of the shielding member 9 is projected from each of associated opposite end portions of the potential regulating member 8 by a projection amount W1 of 10 mm.

### 6-2. Mounting of Shielding Member

Next, mounting of the shielding member 9 in this embodiment will be described.

In this embodiment, the image forming apparatus 1 includes the base 87 as a supporting member for supporting the potential regulating member 8 and the shielding member 9. The base 87 is disposed along (in this embodiment, substantially parallel to) the widthwise direction of the intermediary transfer belt 6 and includes a first supporting portion 87a for supporting the potential regulating member 8 and a second supporting portion 87b for supporting the shielding member 9. The potential regulating member 8 is mounted to the first supporting portion 87a through a pressing spring 89 provided between the potential regulating member 8 (in this embodiment, the base portion 84) and the first supporting portion 87a. Further, the shielding member 9 is mounted to the second supporting portion 87b. As described above, in this embodiment, the shielding member 9 is mounted to the second supporting portion 87b in a part of a region of the first sheet 91 on the base end 91a side with respect to the short direction and a part of a region of the second sheet 92 on the base end 92a side with respect to the short direction. The shielding member 9 can be fixed to the base 87 by an arbitrary fixing means such as bonding with an adhesive, welding, fixing with a double-side tape, or a screen. In this embodiment, the length of the base 87 in the longitudinal direction (widthwise direction of the intermediary transfer belt 6) is substantially the same as the length of the shielding member 9 in the longitudinal direction. Further, in this embodiment, the base 87 is formed of a material (in this embodiment, a resin material) having an electrically insulative property.

Further, in this embodiment, the base 87 is provided with a positioning rib 88 as a position portion for positioning the shielding member 9 when the shielding member 9 is mounted. The positioning rib 88 is provided along the longitudinal direction (widthwise direction of the intermediary transfer belt 6) of the base 87. In this embodiment, the shielding member 9 is stuck on the base 87 so that the base end 9a as a portion-to-be-positioned is abutted against the rib 88. A relative position of the shielding member 9 to the intermediary transfer belt 6 is important similarly as in the case of the potential regulating member 8. In this embodiment, the shielding member 9 is brought into contact with the positioning rib 88, whereby a relative position between the free end 9b of the shielding member 9 and the inner peripheral surface of the intermediary transfer belt 6 is ensured. Incidentally, when the relative position between the shielding member 9 and the intermediary transfer belt 6 can be ensured with sufficient accuracy, a constitution of the positioning portion is not limited to the constitution in this embodiment. For example, a constitution in which an engaging hole as a portion-to-be-positioned provided in the shielding member 9 and an engaging projection as a positioning portion provided on the base 87 are engaged with each other, or the like constitution may be employed.

Further, in this embodiment, the shielding member 9 is provided in an inclined manner so that the free end 9b is positioned on a side upstream of the base end 9a with respect to the feeding direction of the intermediary transfer belt 6. That is, when the shielding member 9 is viewed substantially parallel to the widthwise direction of the intermediary transfer belt 6, the free end 9b of the shielding member 9 which is the other end portion is positioned closer to the intermediary transfer belt 6 than the base end 9a which is one end portion. Further, the shielding member 9 is provided so that the free end 9b is positioned on a side upstream of the base end 9a with respect to the feeding direction of the intermediary transfer belt 6. In this embodiment, as viewed substantially parallel to the widthwise direction of the intermediary transfer belt 6 (rotational axis direction of the photosensitive drum 11), the second supporting portion 87b of the base 87 is constituted by a flat surface inclined relative to a rectilinear line substantially perpendicular to the feeding direction of the intermediary transfer belt 6 with an angle (root angle) 0. Further, to this inclined second supporting portion 87b, a part of a region of flat shielding member 8 on the base end 9a side is mounted.

For that reason, at least a part of a region of the shielding member 9 on the free end 9b side contacts the inner peripheral surface of the intermediary transfer belt 6 in a state in which the region is elastically deformed so as to face toward the primary transfer roller 15 side (from a downstream side toward an upstream side with respect to the feeding direction of the intermediary transfer belt 6). In this embodiment, the rigidity of the first sheet 91 of the shielding member 9 on the free end 91b side projecting toward the inner peripheral surface side of the intermediary transfer belt 6 relative to the free end 92b of the second sheet 92 contacts the inner peripheral surface of the intermediary transfer belt 6 in a state in which the rigidity of the first sheet 91 is electrically deformed so as to face toward the primary transfer roller 15 side.

6-3. Effect by Shielding Member in this Embodiment

By the shielding member 9, the space between the potential regulating member 8 and the primary transfer roller 15 is electrically shielded, so that it is possible to suppress electric discharge through the space between the potential regulating member 8 and the primary transfer roller 15.

Further, a sheet-like member thin in thickness is used as the shielding member 9, and at least a part of a region on the free end 9b side is directed toward the primary transfer roller 15 side, so that the following effects are obtained. First, the shielding member 9 is readily brought near to the primary transfer portion N1 as can as possible while avoiding interference with the primary transfer roller 15 circular in cross section. By this, the potential regulating member 8 is readily brought near to the primary transfer portion N1 as can as possible. Further, it is possible to prevent that the free end 91b of the shielding member 9 is turned up so as to face toward the downstream side of the feeding direction of the intermediary transfer belt 6 and thus the shielding member 9 interferes with the potential regulating member 8.

Further, the shielding member 9 is constituted by the elastic member, particularly two sheet-like members having elasticity in this embodiment, and the free end 91b of the first sheet 91 relatively low in rigidity is contacted to the intermediary transfer belt 6, so that the following effect is obtained.

In the case where the shielding member 9 is contacted to the intermediary transfer belt 6, electrical shielding of the space between the potential regulating member 8 and the primary transfer roller 15 is performed by the intermediary transfer belt 6 and the shielding member 9. However, the intermediary transfer belt 6 fluctuates in position (height) of a surface thereof by displacement due to contact with the potential regulating member 8 and by displacement due to an electrostatic adsorption force between the potential regulating member 8 and the intermediary transfer belt 6 with application of a voltage to the potential regulating member 8. At this time, the shielding member 9 is constituted by the elastic member and is contacted to the inner peripheral surface of the intermediary transfer belt 6 in a state in which the shielding member 9 is elastically deformed in advance, so that even when the intermediary transfer belt 6 is displaced, the shielding member 9 can follow the displacement. By this, a close contact state between the intermediary transfer belt 6 and the shielding member 9 can be maintained.

Accordingly, by the intermediary transfer belt 6 and the shielding member 9, a state in which the space between the potential regulating member 8 and the primary transfer roller 15 is electrically shielded can be maintained. Incidentally, the contact in the state in which the shielding member 9 is electrically deformed in advance corresponds to contact in the electrically deformed state when a stretching state of the intermediary transfer belt 6 is an image formable stretching state (in which the toner image is capable of being primarily transferred onto the intermediary transfer belt 6) and the intermediary transfer belt 6 is at rest (stationary).

On the other hand, in the case where the shielding member 9 is caused to follow the displacement of the intermediary transfer belt 6 by utilizing elasticity of the shielding member 9 as described above, by the shielding member 9, a force for pushing up the surface of the intermediary transfer belt 6 in a contact direction is applied to the intermediary transfer belt 6. Incidentally, a direction in which the surface of the intermediary transfer belt 6 is pushed up is a direction in which an outer peripheral surface of the intermediary transfer belt 6 approaches the photosensitive drum 11 along a direction crossing (in this embodiment, substantially perpendicular to) the feeding direction of the intermediary transfer belt 6 and is a direction in which the inner peripheral surface of the intermediary transfer belt 6 is separated from the potential regulating member 8. In order to bring the shielding member 9 into close contact with the intermediary transfer belt 6 more reliably, it would be considered that the rigidity of the shielding member 9 is made high so that the shielding member 9 is contacted to the intermediary transfer belt 6 by a stronger force. However, in that case, there is a possibility that the potential regulating member 8 is separated from the inner peripheral surface of the intermediary transfer belt 6 by pushing up the intermediary transfer belt 6 by the shielding member 9. In addition, there is a possibility that an electric discharge amount, between the photosensitive drum 11 and the intermediary transfer belt 6, which is an object to be suppressed by the potential regulating member 8 due to rise of the outer peripheral surface of the intermediary transfer belt 6 in a direction approaching the photosensitive drum 11.

On the other hand, in this embodiment, the shielding member 9 is constituted by the two sheet-like members, and the free end 91b of the first sheet 91 relatively low in rigidity is contacted to the intermediary transfer belt 6. By this, the surface of the intermediary transfer belt 6 can be prevented from being excessively pushed up while ensuring the followability of the shielding member 9 to the displacement of the intermediary transfer belt 6. Incidentally, the shielding member 9 is not limited to the shielding member constituted by the two sheet-like members, but may also be constituted by sheet-like members in a further larger number (for example, three to five sheets).

### 6-4. Force Relationship Between Shielding Member and Potential Regulating Member

A force applied to the intermediary transfer belt 6 by each of the potential regulating member 8 and the shielding member 9 will be described more specifically.

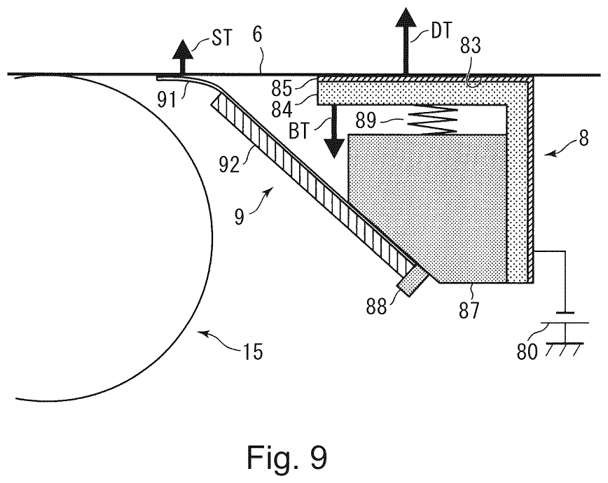

FIG. 9 is a schematic sectional view, in the neighborhood of the primary transfer portion N1, for illustrating a relationship between the force applied to the intermediary transfer belt 6 by each of the shielding member 9 and the potential regulating member 8 and reaction due to tension of the intermediary transfer belt 6.

In this embodiment, during the image forming operation (during the traveling of the intermediary transfer belt 6), it is desired that a state in which the potential regulating member 8 and the shielding member 9 contact the intermediary transfer belt 6 is maintained. Accordingly, the relationship between the force applied to the intermediary transfer belt 6 by each of the shielding member 9 and the potential regulating member 8 and the reaction due to the tension of the intermediary transfer belt 6 is desired to be a force relationship in which such a contact state is maintained.

Here, a force for pushing up the surface of the intermediary transfer belt 6 by the potential regulating member 8 is referred to as DT, a force for pushing up the surface of the intermediary transfer belt 6 by the shielding member 9 is referred to as ST, and reaction due to the tension of the intermediary transfer belt 6 generated by DT and ST is referred to as BT. At this time, from a balance of the forces, the following formula (1) holds.

$$D T + S T = B T \qquad ( 1 )$$

In order to maintain a state in which the potential regulating member 8 contacts the intermediary transfer belt 6, DT>0 may only be required to be satisfied. Further, in order to maintain a state in which the shielding member 9 contacts the intermediary transfer belt 6, ST>0 may only be required to be satisfied. Accordingly, in order to maintain the state in which the potential regulating member 8 and the shielding member 9 contact the intermediary transfer belt 6, a constitution and a shape of the shielding member 9 may only be required to satisfy DT>0 and ST>0 described above, in addition to the above-described formula (1). That is, it is desired to satisfy the following formula (2).

$$D T + S T = BT ( where DT > 0 , ST > 0 ) \qquad ( 2 )$$

Further, in order to bring the potential regulating member 8 into contact with the intermediary transfer belt 6 more reliably, it is preferable that the following formula (3) is satisfied.

$$DT > ST \qquad ( 3 )$$

By using the shielding member 9 satisfying the above-described condition (formula (2) or formulas (2) and (3)), it becomes possible to electrically shield the space between the potential regulating member 8 and the primary transfer roller 15 more reliably. In this embodiment, the shielding member 9 is constituted so as to satisfy the above-described condition (formulas 2 and 3 by setting rigidity (material, thickness, shape, and the like) of the first sheet 91 and the second sheet 92.

Incidentally, each of DT and ST is desired to be small as can as possible in a range satisfying the above-described condition (formula (2) or formulas (2) and (3)). This is because rise of the outer peripheral surface of the intermediary transfer belt 6 in the direction approaching the photosensitive drum 11 is suppressed. By suppressing the rise of the intermediary transfer belt 6, it is possible to suppress consumption of the potential regulating member 8, the shielding member 9, or the intermediary transfer belt 6 due to an increase in electric discharge between the photosensitive drum 11 and the intermediary transfer belt 6 or friction of each of the potential regulating member 8 and the shielding member 9 with the intermediary transfer belt 6.

### 6-5. Modified Embodiment

As described above, in this embodiment, the shielding member 9 is constituted so as to contact the inner peripheral surface of the intermediary transfer belt 6. By this, the space between the primary transfer roller 15 and the potential regulating member 8 is electrically shielded by the shielding member 9 and the intermediary transfer belt 6, so that the electric discharge through the space between the primary transfer roller 15 and the potential regulating member 8 can be suppressed more reliably.

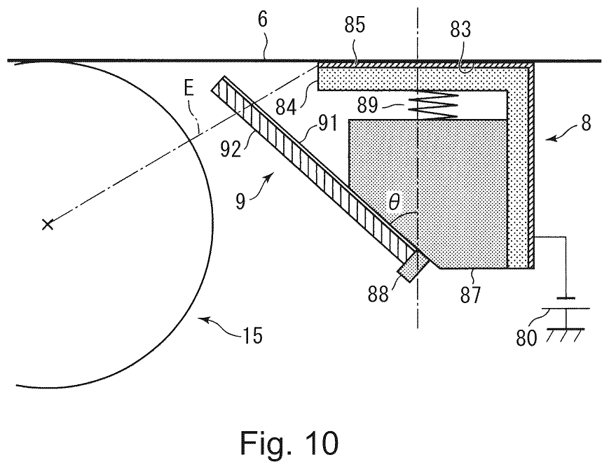

However, as described above, at least as viewed substantially parallel to the widthwise direction of the intermediary transfer belt 6, the shielding member 9 is provided in a region extending across a rectilinear line drawn so as to connect between the primary transfer roller 15 and the potential regulating member 8 (an electroconductive portion (the surface layer 85 in this embodiment) in a shortest distance, so that a corresponding effect is obtained. For example, the shielding member 9 may also have a constitution as shown in FIG. 10. In the example shown in FIG. 10, the shielding member 9 includes a constitution similar to the constitution of the shielding member 9 (FIG. 7) in this embodiment. However, in the example shown in FIG. 10, as regards the shielding member 9, the free end 91b of the first sheet 91 does not project from the free end 92b of the second sheet 92 and does not contact the inner peripheral surface of the intermediary transfer belt 6.

Further, at least as viewed substantially parallel to the widthwise direction of the intermediary transfer belt 6, the shielding member 9 is disposed in the region extending across a rectilinear line E drawn so as to connect between the primary transfer roller 15 and the potential regulating member 8 in a shortest distance. In the case where the primary transfer member is the primary transfer roller 15, as viewed substantially parallel to the widthwise direction of the intermediary transfer belt 6, the rectilinear line E is a rectilinear line drawn so as to connect between a rotation center of the primary transfer roller 15 and the potential regulating member 8 in a shortest distance. Also, in such a constitution, the shielding member 9 is constituted by the sheet-like member, so that the shielding member 9 can be disposed close to the primary transfer roller 15 as can as possible. Further, in such a constitution, the shielding member 9 may preferably be constituted so that opposite end portions thereof with respect to the longitudinal direction project from opposite end portions of the potential regulating member 8 with respect to the longitudinal direction. Further, in such a constitution, the shielding member 9 may also constituted by, for example, a single sheet-like member having a sufficiently electrically insulative property.

Further, as described above, in this embodiment, it is preferable that the shielding member 9 substantially always contacts the inner peripheral surface of the intermediary transfer belt 6 during the image forming operation (during the traveling of the intermediary transfer belt 6). However, also in this embodiment, the shielding member 9 may be, for example, separated from the inner peripheral surface of the intermediary transfer belt 6 temporarily during the image formation (during the traveling of the intermediary transfer belt 6).

Also, in that case, a corresponding effect such that the electric discharge through the space between the primary transfer roller 15 and the potential regulating member 8 is suppressed can be obtained.

### 7. Effect

As described above, according to this embodiment, it becomes possible to suppress the electric discharge (leakage) through the space between the primary transfer roller 15 and the potential regulating member 8.

### Embodiment 2

Next, another embodiment of the present disclosure will be described. Basic structure and operation of an image forming apparatus of this embodiment are the same as those of the image forming apparatus of the embodiment 1. Therefore, in the image forming apparatus of this embodiment, elements having the same or corresponding functions or structures as those of the image forming apparatus of the embodiment 1 are denoted by the same reference numerals or symbols as those of the embodiment 1, and detailed description thereof will be omitted.

In the embodiment 1, the potential regulating member 8 is contacted to the inner peripheral surface of the intermediary transfer belt 6. On the other hand, it is also possible to intend that the potential regulating member 8 is separated from the inner peripheral surface of the intermediary transfer belt 6. Also, in this case, depending on a distance between the inner peripheral surface of the intermediary transfer belt 6 and the potential regulating member 8, or the like, by the action of an electric field formed in the space between the photosensitive drum 11 and the potential regulating member 8, it is possible to obtain an effect of suppressing the electric discharge between the photosensitive drum 11 and the intermediary transfer belt 6. The distance between the inner peripheral surface of the intermediary transfer belt 6 and the potential regulating member 8 (the distance in a direction substantially perpendicular to the feeding direction of the intermediary transfer belt 6). However, for example, when the distance is about 0.5 to 3.0 mm, a sufficient effect is obtained in some cases.

In this embodiment, the potential regulating member 8 is disposed separately from the inner peripheral surface of the intermediary transfer belt 6.

A constitution of the potential regulating member 8 in this embodiment is substantially the same as that in the embodiment 1. However, in this embodiment, the potential regulating member 8 is disposed so that a surface thereof corresponding to the contact surface 83 of the potential regulating member 8 in the embodiment 1 is substantially parallel to the inner peripheral surface of the intermediary transfer belt 6 and so that a distance of the surface from the inner peripheral surface of the intermediary transfer belt 6 becomes about 1.0 mm.

The potential regulating member 8 is disposed separately from the intermediary transfer belt 6, so that it is possible to reduce a possibility that abrasion of the potential regulating member 8 and scars of the inner peripheral surface of the intermediary transfer belt 6 due to contact of the potential regulating member 8 with the intermediary transfer belt 6 occur.

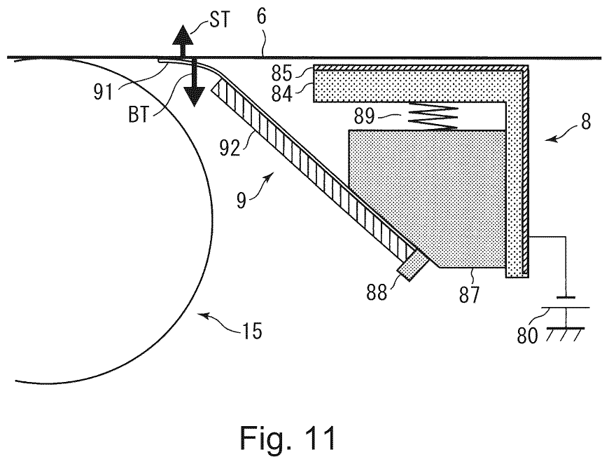

FIG. 11 is a schematic sectional view, in the neighborhood of the primary transfer portion N1, for illustrating a relationship between a force applied to the intermediary transfer belt 6 by each of the shielding member 9 and the potential regulating member 8 and reaction due to tension of the intermediary transfer belt 6 in the case where the potential regulating member 8 does not contact the intermediary transfer belt 6.

As shown in FIG. 11, in the case where the potential regulating member 8 does not contact the intermediary transfer belt 6, a reaction force is not generated between the potential regulating member 8 and the intermediary transfer belt 6, but a reaction force of the intermediary transfer belt 6 by a force applied from the shielding member 9 and displacement of the intermediary transfer belt 6 at that time are generated. At this time, when the displacement of the intermediary transfer belt 6 by a force for pushing up the intermediary transfer belt 6 by the shielding member 9 becomes large, a distance between the potential regulating member 8 and the intermediary transfer belt 6 becomes wide, so that it leads to reduction of the effect of suppressing the electric discharge between the photosensitive drum 11 and the intermediary transfer belt 6. Accordingly, in this embodiment, it is desired that the shielding member 9 is constituted so that the following formula (4) is satisfied. Incidentally, similar to the embodiment 1, the force for pushing up the surface of the intermediary transfer belt 6 by the shielding member 9 is ST, and the reaction due to the tension of the intermediary transfer belt 6 generated by ST is BT.

$$ST = BT ( where ST > 0 ) \qquad ( 4 )$$

Further, in order to make the distance between the potential regulating member 8 and the intermediary transfer belt 6 substantially constant, the following formula (5) may preferably be satisfied. Incidentally, displacement of the surface of the intermediary transfer belt 6 when the surface of the intermediary transfer belt 6 is pushed up by ST is referred to as BS [mm]. This displacement is displacement in a direction crossing (in this embodiment, substantially perpendicular to) the feeding direction of the intermediary transfer belt 6.

$$0 [ mm ] < BS \leq 0.5 [ mm ] \qquad ( 5 )$$

According to study by the present inventor, in a constitution of this embodiment, when BS is 0.5 mm or less, a fluctuation in effect of suppressing the electric discharge between the intermediary transfer belt 6 and the photosensitive drum 11 by the potential regulating member 8 can be sufficiently suppressed. BS may also be substantially 0 mm. Incidentally, this can also be said similarly in the constitution in which the potential regulating member 8 contacts the inner peripheral surface of the intermediary transfer belt 6 as in the embodiment 1. However, depending on a constitution of the potential regulating member 8, an upper limit value of BS may also be changed.

By using the shielding member 9 satisfying the above-described condition, also in the constitution in which the potential regulating member 8 is disposed separately from the intermediary transfer belt 6, it becomes possible to electrically shield the space between the potential regulating member 8 and the primary transfer roller 15 more reliably.

### Other Embodiments

In the above, the present disclosure was described based on specific embodiments, but the present disclosure is not limited to the above-described embodiments.

In the above-described embodiments, the constitution and arrangement of the potential regulating member 8 more described on the assumption that the potential regulating member 8 has the constitution shown in FIG. 4, but the potential regulating member 8 may also have the constitutions as shown in FIGS. 3 and 5. Further, in the above-described embodiments, the potential regulating member 8 has the constitution including the first portion 81 and the second portion 82, but the potential regulating member 8 may also be constituted by, for example, a flat plate corresponding to the first portion 81 in the above-described embodiments. Further, the potential regulating member 8 may have another form such as a black-like member having a rectangular shape, for example.

Further, the shielding member may also be lowered in rigidity on the free end side than on the base end side by being constituted by the single sheet-like member and being changed in thicknesses thereof on the free end side and the rear end (base end) side with respect to the short direction.

Further, in the case where the first sheet and the second sheet which constitute the shielding member are fixed to each other, an order of superposition may also be opposite to the order in the above-described embodiments.

Further, the shielding member can also be constituted by an elastic member, such as a rubber, having an electrically insulative property and elasticity, and can be formed in an arbitrary shape.

Further, in the above-described embodiments, the primary transfer member was the roller-shaped member, but may also be a brush-like member, a sheet-like member, a pad-like member, and the like.

Further, in the above-described embodiments, the potential regulating power source was provided independently for each of the image forming units, but may also be made common to the plurality (or all) of image forming units. The same applies to the charging power source, the developing power source, and the primary transfer power source.

Further, in the above-described embodiments, the predetermined charge polarity of the photosensitive member was the negative polarity, but is not limited thereto. The predetermined charge polarity of the photosensitive member may also be the positive polarity. Similarly, in the above-described embodiments, the normal charge polarity of the toner was the negative polarity, but may also be the positive polarity. Various applied voltages in the case where the predetermined charge polarity of the photosensitive member and the normal charge polarity of the toner are the positive polarity may only be required to be appropriately changed such that these polarities are changed to the polarity opposite to the polarity in the above-described embodiments in accordance with the above-described embodiments.

Further, the image forming apparatus can have a constitution including the potential regulating member and the shielding member for at least one of the plurality of image forming units. That is, the image forming apparatus can have a constitution in which the potential regulating member and the shielding member are provided on the inner peripheral surface side of the intermediary transfer belt in a position immediately close to at least one of the plurality of primary transfer portions on a side downstream of the associated primary transfer portion.

Further, the image forming apparatus is not limited to the image forming apparatus capable of forming a full-color image, but may also be an image forming apparatus capable of forming only a monochromatic (white/black or monocolor) image.

According to the present disclosure in a constitution in which a bias of the same polarity as a charge polarity of a photosensitive member is applied to an electrode member disposed on a side downstream of a primary transfer portion, it is possible to suppress electric discharge through a space between a primary transfer member and the electrode member.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-188679, filed on Oct. 25, 2024, which is hereby incorporated by reference herein in its entirety.

What is claimed is:

1. An image forming apparatus comprising:
a photosensitive member capable of being electrically charged to a predetermined polarity and configured to bear a toner image;
an intermediary transfer belt configured to convey the toner image transferred from the photosensitive member and capable of being circulated and moved;
a transfer member forming a transfer portion, where the photosensitive member and the intermediary transfer belt contact each other, in contact with an inner peripheral surface of the intermediary transfer belt, and configured to transfer the toner image from the photosensitive member onto the intermediary transfer belt in the transfer portion under application of a voltage;
an electrode member provided on a side downstream of the transfer portion with respect to a movement direction of the intermediary transfer belt and on an inner peripheral surface side of the intermediary transfer belt; and
a power source configured to apply a voltage of the same polarity as a predetermined polarity to the electrode member;
a supporting portion configured to support the electrode member; and
an elastic sheet member provided to the supporting portion so as to contact the inner peripheral surface of the intermediary transfer belt and which is elastically deformable and electrically insulative, the elastic sheet member being provided in a region extending across a rectilinear line drawn so as to connect the transfer member and the electrode member in a shortest distance when the elastic sheet member is viewed substantially parallel to a widthwise direction of the intermediary transfer belt.

2. The image forming apparatus according to claim 1, wherein the elastic sheet member is provided in the region extending across the rectilinear line drawn so as to connect the transfer member and the electrode member in the shortest distance at least when the elastic sheet member is viewed substantially parallel to the widthwise direction of the intermediary transfer belt.

3. The image forming apparatus according to claim 1, wherein the elastic sheet member is provided so that one side surface thereof faces a transfer member side and the other side surface thereof faces an electrode member side.

4. The image forming apparatus according to claim 1, wherein the elastic sheet member includes a base end which is one end portion and a free end which is the other end portion, and
wherein when the elastic sheet member is viewed substantially parallel to the widthwise direction of the intermediary transfer belt, the elastic sheet member is disposed so that the free end is positioned closer to the intermediary transfer belt than the base end is and so that the free end is positioned on an upstream side with respect to the movement direction.

5. The image forming apparatus according to claim 1, wherein the elastic sheet member contacts the inner peripheral surface of the intermediary transfer belt at least in a portion thereof on a free end side thereof.

6. The image forming apparatus according to claim 1, further comprising a sheet supporting portion provided to the supporting portion and configured to support a surface of the elastic sheet member on a side opposite from the electrode member,
wherein a region of a part of the elastic sheet member on a free end side thereof is projected toward an inner peripheral surface side of the intermediary transfer belt relative to a free end of the sheet supporting portion on the free end side of the elastic sheet member, and at least a part of the projected region of the elastic sheet member contacts the inner peripheral surface of the intermediary transfer belt.

7. The image forming apparatus according to claim 1, wherein the electrode member is provided so as to contact the inner peripheral surface of the intermediary transfer belt and the elastic sheet member is provided so as to contact the inner peripheral surface of the intermediary transfer belt, and
wherein a force by which the elastic sheet member displaces a surface of the intermediary transfer belt in a direction crossing the movement direction by contact thereof with the inner peripheral surface of the intermediary transfer belt is smaller than a force by which the electrode member displaces the surface of the intermediary transfer belt in the direction crossing the movement direction by contact thereof with the inner peripheral surface of the intermediary transfer belt.

8. The image forming apparatus according to claim 1, wherein with respect to the widthwise direction of the intermediary transfer belt, opposite end portions of the elastic sheet member are projected outward relative to opposite end portions of the electrode member, respectively.

9. An image forming apparatus comprising:
a photosensitive member capable of being electrically charged to a predetermined polarity and configured to bear a toner image;
an intermediary transfer belt configured to convey the toner image transferred from the photosensitive member and capable of being circulated and moved;
a transfer member forming a transfer portion, where the photosensitive member and the intermediary transfer belt contact each other, in contact with an inner peripheral surface of the intermediary transfer belt, and configured to transfer the toner image from the photosensitive member onto the intermediary transfer belt in the transfer portion under application of a voltage;
an electrode member provided on a side downstream of the transfer portion with respect to a movement direction of the intermediary transfer belt and on an inner peripheral surface side of the intermediary transfer belt; and
a power source configured to apply a voltage of the same polarity as a predetermined polarity to the electrode member;
a supporting portion configured to support the electrode member; and
an electrically insulating member provided to the supporting portion so as not to contact the intermediary transfer belt and provided in a region extending across a rectilinear line drawn so as to connect the transfer member and the electrode member in a shortest distance when the electrically insulating member is viewed substantially parallel to a widthwise direction of the intermediary transfer belt.

10. An image forming apparatus comprising:
a photosensitive member capable of being electrically charged to a predetermined polarity and configured to bear a toner image;
an intermediary transfer belt configured to convey the toner image transferred from the photosensitive member and capable of being circulated and moved;
a transfer member forming a transfer portion, where the photosensitive member and the intermediary transfer belt contact each other, in contact with an inner peripheral surface of the intermediary transfer belt, and configured to transfer the toner image from the photosensitive member onto the intermediary transfer belt in the transfer portion under application of a voltage;
an electrode member provided on a side downstream of the transfer portion with respect to a movement direction of the intermediary transfer belt and on an inner peripheral surface side of the intermediary transfer belt; and
a power source configured to apply a voltage of the same polarity as a predetermined polarity to the electrode member;
a supporting portion configured to support the electrode member; and
an insulating member provided to the supporting portion so as to extend across a rectilinear line drawn so as to connect the transfer member and the electrode member in a shortest distance when the insulating member is viewed substantially parallel to a widthwise direction of the intermediary transfer belt,
wherein with respect to the widthwise direction of the intermediary transfer belt, opposite end portions of the insulating member are projected outward relative to opposite end portions of the electrode member, respectively.
